(19) United States
(12) Patent Application Publication
(10) Pub. No.: US 2002/0184218 A1
(43) Pub. Date: Dec. 5, 2002

(54) System and method for implementing security on a database

(76) Inventors: Steven C. Bailey, Washington, IL (US); Stephen W. Blessin, Dunlap, IL (US); Gary L. Lewis, Princeville, IL (US)

Correspondence Address: W. Bryan McPherson III, Caterpillar Inc., Intellectual Property Department, AB6490, 100 N.E. Adams Street, Peoria, IL, 61629-6490, US

(21) Appl. No.: 10/044,736

(22) Filed: Jan. 11, 2002

Related U.S. Application Data
(60) Provisional application No. 60/294,924, filed on May 31, 2001.

(51) Int. Cl. G06F 17/30; G06F 7/00

(52) U.S. Cl. 707/9

(57) ABSTRACT

The present invention describes a method of restricting user access to parcels of data in a database. Each user of the database may be given a specified security level depending on their needs for their job. Further, each parcel of data in the database may be assigned a particular security threshold that determines its ability to be accessed by users. Both the security threshold of parcels of data, and security levels of users can be easily changed by a user with administrator status. Further an administrator is able to allow a user to access a particular parcel of data whose security threshold is greater than the users security level, by means of an override. The present invention is easily adaptable to help restrict search results of a search of a database, so that each user could receive different results, based on their security level and overrides, from the same initial search.

### TECHNICAL FIELD

The present invention relates generally to searching data such as in electronic commerce (“e-commerce”) and more particularly to a system and method of implementing restricted access to a database in an e-procurement context.

### BACKGROUND

For purposes of explaining the specification of this invention and for purposes of making clear the intended scope of the appended claims, the following definitions of key terms are provided:

1. attribute characteristic: a particular quality(ies) that restricts or gives a particular form to the part it characterizes (i.e. shape, color, length).

2. specific attribute: the value of an attribute characteristic (i.e. oval, blue, 2.5 inches)

3. parcel of data: a level of abstraction i.e. a catalog, a part, an attribute characteristic relating to a part, or a price. Thus, a whole catalog of items or parts, attributes describing those items or parts, the prices of those items or parts, or the items and parts themselves all are parcels of data.

4. name: one or more of the elements of a keyword having a specific set of attribute characteristics, wherein keyword represents the name or string of names for initiating a search for an part. (i.e. DRILL/CARBIDE/SOLID OR TIPPED/MF2042 which is understood as an MF2042 solid or tipped carbide drill where MF2042 designates a unique configuration for parts of a particular family group of parts purchased or made by the user.

Database access is a very important aspect of database management. With regard to procurement, providing more information to a user than needed may be as detrimental as not providing enough information to a user. There are many situations where certain users do not need to have access to certain parcels of data within a database. It is possible that the data is just unnecessary for a user and will thus waste their time looking at it. For example, a user who only deals with tooling aspects of a business, need not see data that involves office products when querying a database. Maybe the data is of a very sensitive nature, and only particular users should have access to it. An example of this might be the pricing information of a particular part. Maybe certain information would just clutter the judgement of a user, and the user would make a non-efficient decision. For example, a user might just need to know length, width and height of a part, but not what it is made of. If the user was aware of such information, he might base a decision on a characteristic of a part that has nothing to do with his job, and thus interfere with another user, whose job is to determine the material required for a part.

The present invention is directed to overcoming one or more of the problems set forth above.

### SUMMARY OF THE INVENTION

In one aspect of the present invention, a method of restricting user access to parcels of data in a database of product items used in a procurement system is disclosed. The method includes the steps of assigning a security threshold to each parcel of data in the database, assigning a security level to each user of the database, and allowing access to a particular parcel of data to a particular user when the security level of the particular user is at least equal to the security threshold of the particular parcel of data.

### BRIEF DESCRIPTION OF THE DRAWINGS

The subject matter regarded as the invention is particularly pointed out and distinctly claimed in the concluding portion of the specification. The invention, however, both as to organization and method of operation, may best be understood by reference to the following detailed description, when read with the accompanying drawings, in which:

FIG. 1 illustrates the necessary database tables for the present invention.

FIG. 2 illustrates the login screen for an administrator to get into the system.

FIGS. 3A-3C illustrate the managing keyword screens that appear after first logging into the system.

FIGS. 4A-4G illustrate the adding and subtracting of an administrator from a catalog.

FIGS. 5A-5C illustrate an administrator selecting a keyword that he can apply different security thresholds to.

FIGS. 6A-6G illustrate show the effects of the changing of a security threshold and the changing of the security level of a user affects a search.

FIGS. 7A-7C illustrate how to apply a security override to a user with respect to a specific attribute characteristic.

FIGS. 8A-8E illustrate how to affect a security override of a user with respect to a part.

FIG. 9 illustrates the log kept by the system.

FIGS. 10A-10D illustrate how to find a keyword using the keyword search ability of the system.

FIGS. 11A-11B illustrate how to find a part using the part search ability of the system.

FIGS. 12A-12D illustrate how to change the security threshold of price data of parts.

FIG. 13 is a simplistic diagram of a computer network system that is suitable for practicing the preferred embodiment of the present invention.

FIGS. 14A-14G illustrate whole and individual portions of images displaying exemplary screens within the global search module 44.

### DETAILED DESCRIPTION

A system and method for implementing security in a database is described below. Although numerous specific details are set forth in order to provide a through understanding of the present invention, it will be apparent to one skilled in the art that the present invention may be practiced without such specific details. For example, much of the following description discusses database tables and fields used to create a setup that will enable the present invention to work. The tables and fields described in the present invention however can be implemented in a variety of ways and combinations to achieve the same effect.

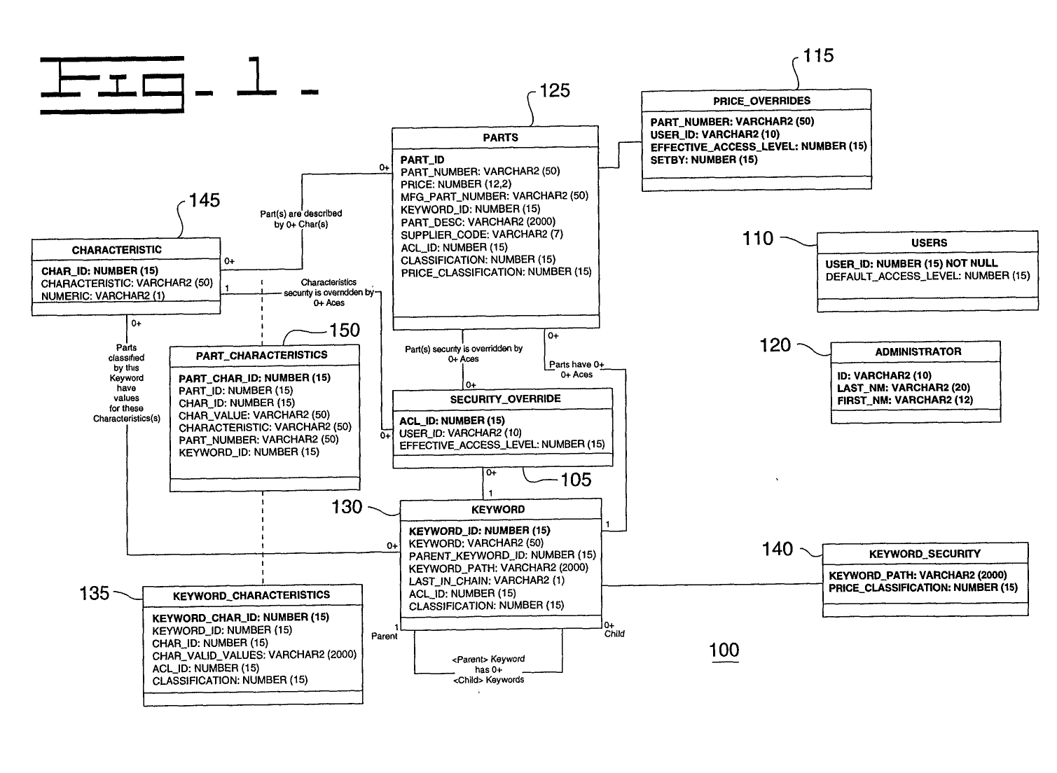

In one embodiment of the present invention, there are ten tables in the relational database: a security override table 105, a users table 110, a price override table 115, an administrator table 120, a part table 125, a keyword table 130, a keyword characteristic table 135, a keyword security table 140, a characteristic table 145 and a part characteristic table 150. One embodiment of this table system 100 is displayed in FIG. 1. These ten tables enable a database to customize the security of the parcels of data in a powerful and unique way.

One of the tables, specifically the security overide table 105, is used to hold information regarding which users have a security override for a particular parcel of data. If a users security level is not high enough to see a particular parcel of data, an override can be created to give the user access to a particular parcel of data. In the preferred embodiment, this security override table 105 contains three pieces of data. One piece or field contains a unique number corresponding to each individual override for a particular parcel of data and is, when in combination with the field that is used to identify a particular user of the database, the primary key of this table. Each override corresponds to a particular user and particular parcel of data. The user identification field is part of what allows identification to happen. This field also stores which user has been given an override to particular parcels of data. Lastly, the table needs a field to determine if an override is still required. When a security threshold of a parcel of data, or security level of a user changes, the database will then look at all of the parcels of data or users affected by such a switch. For example, if a users security level is 20, and the part he wants to see has a security threshold of 30, he will be unable to see it unless he has an override. If for some reason his security level is raised to 30, or the part security threshold is reduced to 20, the override is no longer needed, and thus takes up valuable storage space in the database. By comparing a particular override with the security level of a parcel of data, the system will be able to determine if the override is needed, and if not, eliminate it thus saving space in the database.

Another required table is the user table 110 which is used to keep a list of users who have administrative abilities for a particular catalog. A user who qualifies as an administrator is allowed to change the default access levels of users who have access to the database as well as overrides for particular users regarding a particular parcel of data. In the preferred embodiment, the user table 110 includes two fields. One is a field that is a unique number corresponding to each individual administrator of a database and is the primary key of this table. The other field is used to store the security level assigned to a particular user. A security level, for example, is a number from 0 to 40 (typically in multiples of five), where a user whose default_access_level is 0 has the lowest access, and if it is 40 he has the highest.

Another table, used in one embodiment, is the price override table 115 which is used to hold information regarding which users have a price override for a particular price relating to a specific part. This price override table 115 is used in a similar way to the security override table 105. If a users' security level is not high enough to see a particular price relating to a specific part, an override can be created to give the user access to that particular price relating to a specific part. In the preferred embodiment, table 115 includes three fields. One field is a unique number corresponding to each individual override for a particular price relating to a specific part and this field is the primary key of this table. Another field contains the part number that the price override is associated with and thus, is a foreign key of this table. Another field relates the price override table 115 to the part table 125 in a one-to-many relationship. Each part is associated with zero, one or many price overrides, but each price override is associated with only one part. Each override corresponds to a particular user and particular price relating to a specific part. This field is part of what allows identification to happen. This field stores which user has been given an override to a particular price relating to a specific part. Another field is used to determine if an override is still required. When a security threshold of a particular price relating to a specific part, or security level of a user changes, the system will look at all of the particular prices relating to specific parts or users affected by such a switch. For example, if a users security level is 20, and the particular price relating to a specific part he wants to see has a security threshold of 30, he will be unable to see it unless he has an override. If for some reason his security level is raised to 30, or the particular price relating to a specific part security threshold is reduced to 20, the override is no longer needed, and thus takes up valuable storage space in the database. By comparing this field of a particular override with a field containing the price security level of a part, the system will be able to determine if the override is needed, and thus save space in the database.

The administrator table 120 is used to store which users are considered super administrators in the system. A super administrator is allowed to not only change security thresholds, security levels and perform overrides, but also is allowed to determine which users of the system can become administrators. In the preferred embodiment, this table contains three fields. One field includes is a unique number corresponding to each individual user who is given super administrator power and this field is the primary key of this table. Another field is used to store the last name of a user who is given super administrator power. One more field is used to store the first name of a user who is given super administrator power.

Another table, used in one embodiment of the present invention, is the characteristic table 145 which is used to hold information about the names of all of the attribute characteristics there are in the database. For example, shape, color, material type, length, and point style would each have a row in the characteristic table 145 associated with it. In the preferred embodiment, this table 145 contains three fields. One field is a unique number corresponding to each individual attribute characteristic and is the primary key of this table. Another field is a text string that is used for the name of an attribute characteristic. Thus, the text “shape” or “color” would be stored in this field. Another field is used to determine if the characteristic has specific attributes that would be numbers and thus requires an “N” if not or a “Y” if so. Thus, a characteristic table row associated with the attribute characteristic color, would likely have an “N” in this field, where the characteristic table 145 associated with length would likely have a “Y” in this field.

The keyword table 130 is used to hold information regarding keywords, and aid in the construction of the keyword tree folder structure. Thus, if the name of a part is DRILL/CARBIDE/SOLID OR TIPPED/MF2042, either DRILL or CARBIDE or SOLID OR TIPPED or MF2042 each would be described in a row in the keyword table 130. Each individual keyword row becomes a branch of the keyword tree folder structure. In the preferred embodiment, this table 130 involving keywords contains seven fields. One field is a unique number corresponding to each individual keyword. Thus, this field is the primary key of this table 130. Another field is a text string that is used for the name of a keyword. In this example, the text “DRILL” or “CARBIDE” would be stored in this field. Another field contains the unique number associated with the folder (parent) in which the current keyword is contained. Thus, CARBIDE would have the unique number of the keyword DRILL in this field. DRILL on the other hand has no parent and is thus a first branch. As a result, this field will contain the number zero. Another field contains the path of keywords leading up to the current one. Thus, the SOLID OR TIPPED keyword table would have DRILL/CARBIDE/SOLID OR TIPPED in this field. Another field contains either a “Y” or “N” depending on whether or not it is the last keyword in a name. Thus, in the example DRILL/CARBIDE/SOLID OR TIPPED/MF2042, MF2042 would contain a “Y” in this field, while CARBIDE would contain an “N”. Another field contains an override that a keyword is associated with. This field is a foreign key of this table and relates the security overrides table 105 to this table 130 in a one-to-many relationship. Each keyword is associated with zero, one or many overrides, but each override is associated with only one keyword. Another field is used to store the current security threshold level of a particular keyword. The security threshold, for example, is a number from 0 to 40 (typically in multiples of five), where a keyword whose classification field is 0 has the lowest security threshold, and if it is 40 it has the highest. This field is also used in determining whether or not overrides are still needed for this particular keyword, as discussed above.

Another table that may be used, specifically the parts table 125, is used to hold information about particular parts. Thus, each particular part has a row in the parts table associated with it. In the preferred embodiment, this table 125 includes four fields. One field is a unique number corresponding to each individual part. Thus, this field is the primary key of this table. Another field contains an override that a part is associated with. This field is a foreign key of this table and relates the security overrides table 105 to this table 125 in a one-to-many relationship. Each part is associated with zero, one or many overrides, but each override is associated with only one part. Another field is used to store the current security threshold level of a particular part. In the preferred embodiment, this entry is a number from 0 to 40 (typically in multiples of five), where a part whose classification field is 0 has the lowest security threshold, and if it is 40 it has the highest. This field is also used in determining whether or not overrides are still needed for this particular part, as discussed above. Another field would contain the price of a particular part. Another field contains the unique keyword number that a part is associated with. This field is a foreign key of this table and relates the table involving parts to this table in a one-to-many relationship. Each keyword is associated with zero, one or many parts, but each part is associated with only one keyword. Another field contains the security override number that a part is associated with.

Another table that may be used is the part characteristics table 150 which is used to store the specific attribute of an attribute characteristic of a particular part. In one embodiment, this table 150 contains four fields. One field is a unique number corresponding to each individual specific attribute of an attribute characteristic of a particular part. Thus, this field is the primary key of this table. Another field contains the part identification that a specific attribute of an attribute characteristic is associated with. This field is a foreign key of this table and relates the parts table 125 to this table 150 in a one-to-many relationship. Each part is associated with zero, one or many specific attributes of attribute characteristics, but each specific attribute of an attribute characteristic is associated with only one part. Another field contains the characteristic id that a specific attribute of an attribute characteristic are associated with. This field is also a foreign key of this table and relates this table 150 to the characteristics table 145 in a one-to-many relationship. Each part characteristic is associated with zero, one or many specific attributes of attribute characteristics, but each specific attribute of an attribute characteristic is associated with only one part characteristic. Another field is used to store the specific attribute of an attribute characteristic. Thus the actual length of a part, i.e. 6 in., or the color of an part, i.e. blue, would be stored in this field. Another field contains the unique keyword number that a specific attribute of an attribute characteristic is associated with. This field is a foreign key of this table 150 and relates the keyword table 130 to the part characteristics table 150 in a one-to-many relationship. Each keyword is associated with zero, one or many specific attributes of attribute characteristics, but each specific attribute of an attribute characteristic is associated with only one keyword.

The keyword security table 140 is used to store the price classification level of a keyword. In the preferred embodiment, this table 140 contains two fields. One field is a unique name corresponding to each individual keyword. Thus this field is the primary key of this table. Another field is used to store the current security threshold level of a particular keyword. The security threshold, for example, is a number from 0 to 40 (typically in multiples of five), where a keyword, whose classification field is 0, has the lowest security threshold, and if it is 40 it has the highest. This field is also used in determining whether or not overrides are still needed for this particular keyword, as discussed above.

The keyword characteristics table 135 is used to contain all of the specific attributes of one attribute characteristic of all the parts that are associated with one name. Thus, for the name DRILL/CARBIDE/SOLID OR TIPPED/MF2042 all of the specific attributes of the attribute characteristic “overall length” of all the parts associated with that name will be stored in a row in this table 135. In the preferred embodiment, this table 135 contains six fields. One field is a unique number corresponding to each individual keyword. Thus, this field is the primary key of this table. Another field contains the unique keyword number that a specific attribute of an attribute characteristic is associated with. This field is a foreign key of this table and relates this table 135 to the keyword table 130 in a one-to-many relationship. Each keyword is associated with zero, one or many keyword characteristics, but each keyword characteristic is associated with only one keyword. Another field contains the unique characteristic number that a specific attribute of an attribute characteristic is associated with. This field is a foreign key of this table and relates this table to the characteristic table in a one-to-many relationship. Each characteristic is associated with zero, one or many keyword characteristics, but each keyword characteristic is associated with only one characteristic. Another field contains a unique number corresponding to each individual override for a particular keyword characteristic. This field is a foreign key of this table 135 and relates the security overrides table 105 to this table in a one-to-many relationship. Each keyword characteristic is associated with zero, one or many overrides, but each override is associated with only one keyword characteristic. Another field is used to store the current security threshold level of a particular price relating to a specific part. In the preferred embodiment, this entry is a number from 0 to 40 (typically in multiples of five), where a part with 0 in this field has the lowest security threshold, and if it is 40 it has the highest. This field is also used in determining whether or not price overrides are still needed for this particular part, as discussed above. Another field is used to store the current security threshold level of a particular keyword characteristic. The security threshold, for example, is a number from 0 to 40 (typically in multiples of five), where a keyword characteristic with 0 in this field has the lowest security threshold, and if it is 40 it has the highest. This field is also used in determining whether or not overrides are still needed for this particular keyword characteristic, as discussed above.

Although the above tables are the only tables fully described, there is no reason in alternative embodiments that there could not be additional tables connected to the above tables in various ways. There also is no reason why there couldn't be additional fields added for a particular application or use.

Security

Each user is given a default access level that has been predetermined by, for example, a business entity. In one embodiment, there are five different security levels a user can receive: Public, which is equal to zero (0), Green, which is equal to twenty (20), Yellow, which is equal to thirty (30), Yellow(R) (Yellow with restriction) which is equal to thirty-five (35) and Red which is equal to forty (40). Red is the highest security level, where as public is the lowest. In one embodiment, an employee of the business entity is given a default access level of thirty (30), contract worker is given twenty (20), a supplier is given ten (10), a dealer is given ten (10), and a customer is given ten (10). Based on their default access levels, the user will be able to see a predetermined amount of information. For example, price data may be given an access level of thirty-five (35). Because the employee default access of thirty (30) is the highest given by default, an employee will not be able to see price data. In order to overcome an initial setting, the user must have an override for any parcels of data that he is currently unable to see. This is accomplished by an administrator (or super administrator) giving a user such an override to see those parcels of data. Thus, a user is by default unable to see any data that the corporation has previously determined to be above the security level of a user, without some affirmative action done by an administrator. Thus data has a much greater chance of staying secure and being shown to those users who truly have a need to see it.

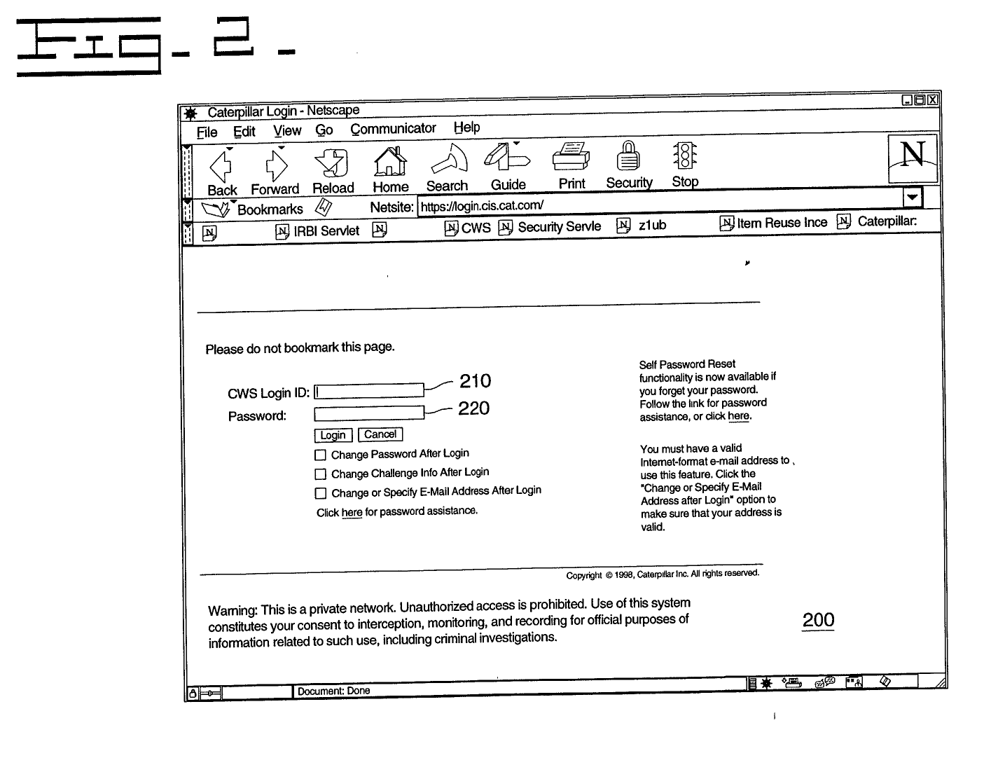

In one embodiment, when a administrator wants to log into the system security he first must log into the system as generally indicated by numeral 200 in FIG. 2. Each administrator then needs to enter a Login ID 210 and a Password 220.

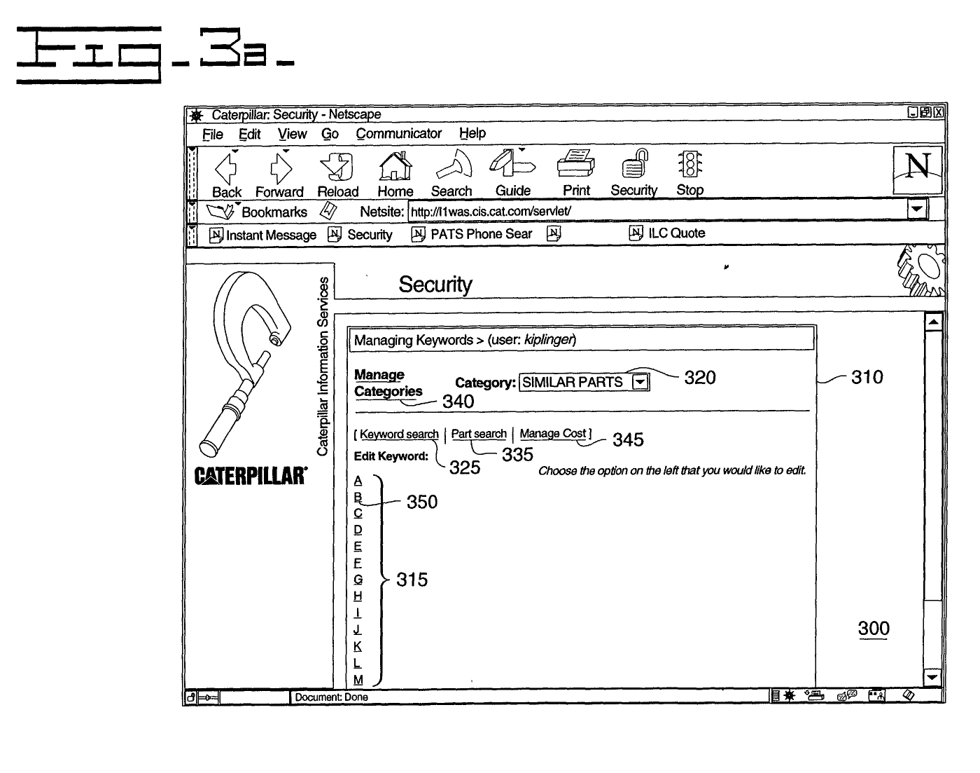

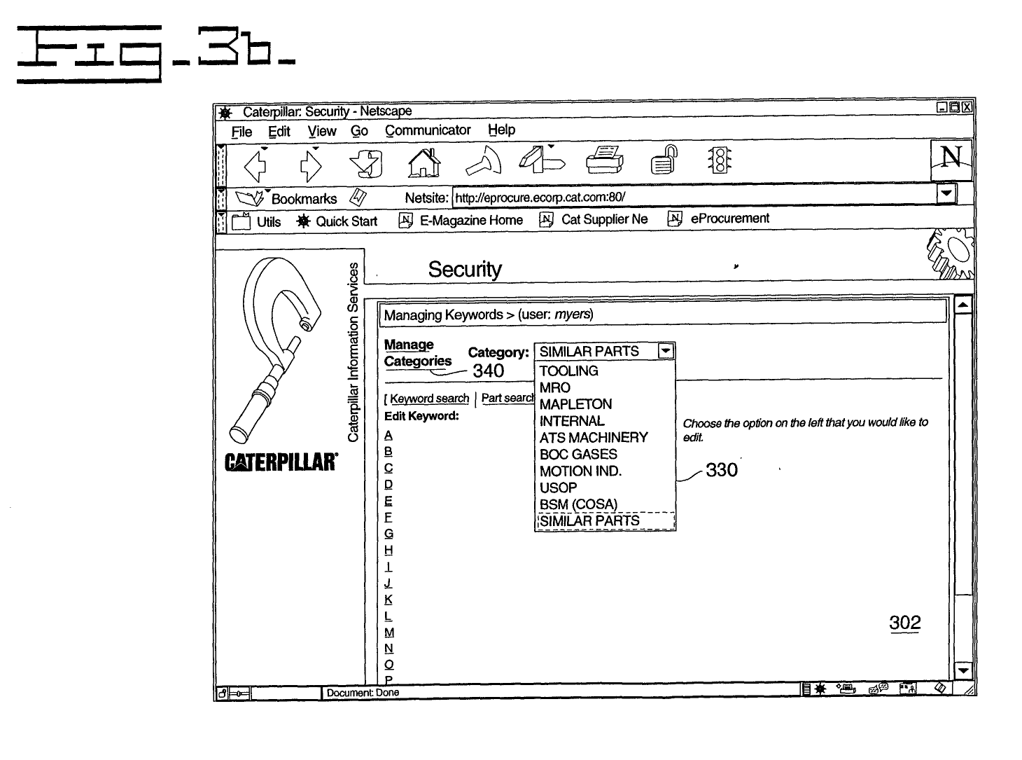

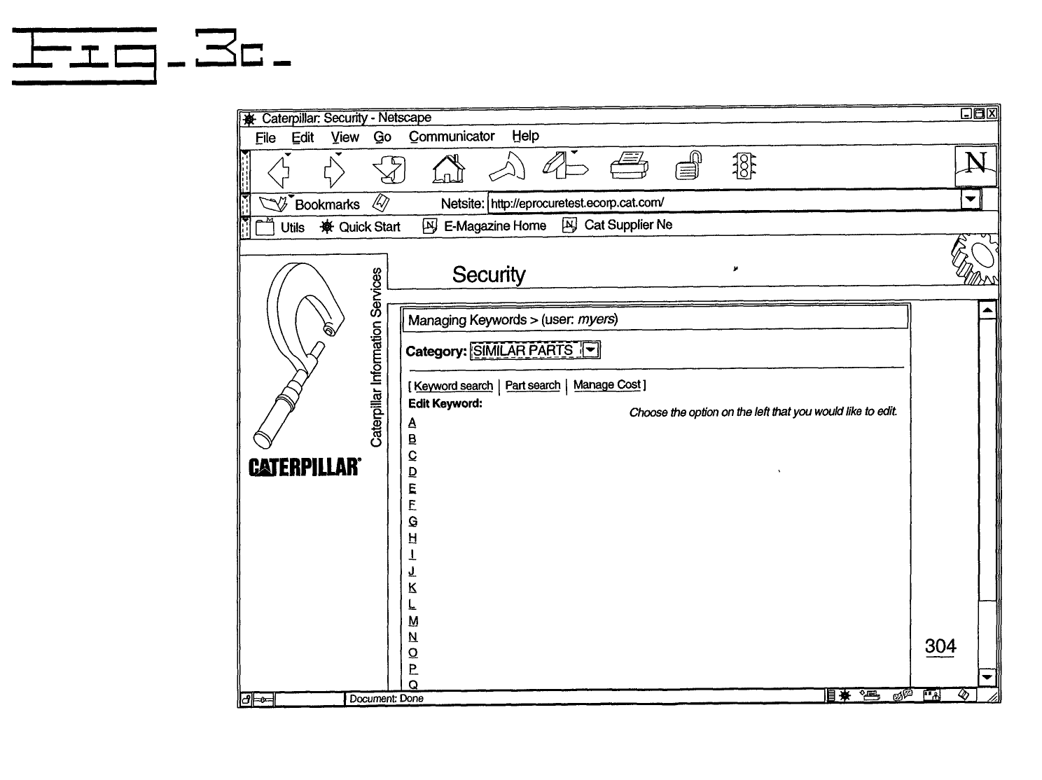

If the login is successful, an administrator will see a screen indicated by numeral 300 in FIG. 3A. The administrator is presented with a managing keywords window 310. In this window he has several options. First, he may choose the proper catalog in which he wants to modify security levels. The user will choose the catalog from category selection box 320. The administrator might have multiple catalogs in which to be able to administer, and will select the proper one from drop-down menu 330 as generally indicated by numeral 302 in FIG. 3B. In one embodiment, each catalog presented to him requires that he has an entry in that catalogs' users table. After the proper catalog has been selected, an administrator can then begin the process of editing the security threshold of either a keyword, a part, a price, or the security level of a user with respect to a particular keyword, part or price.

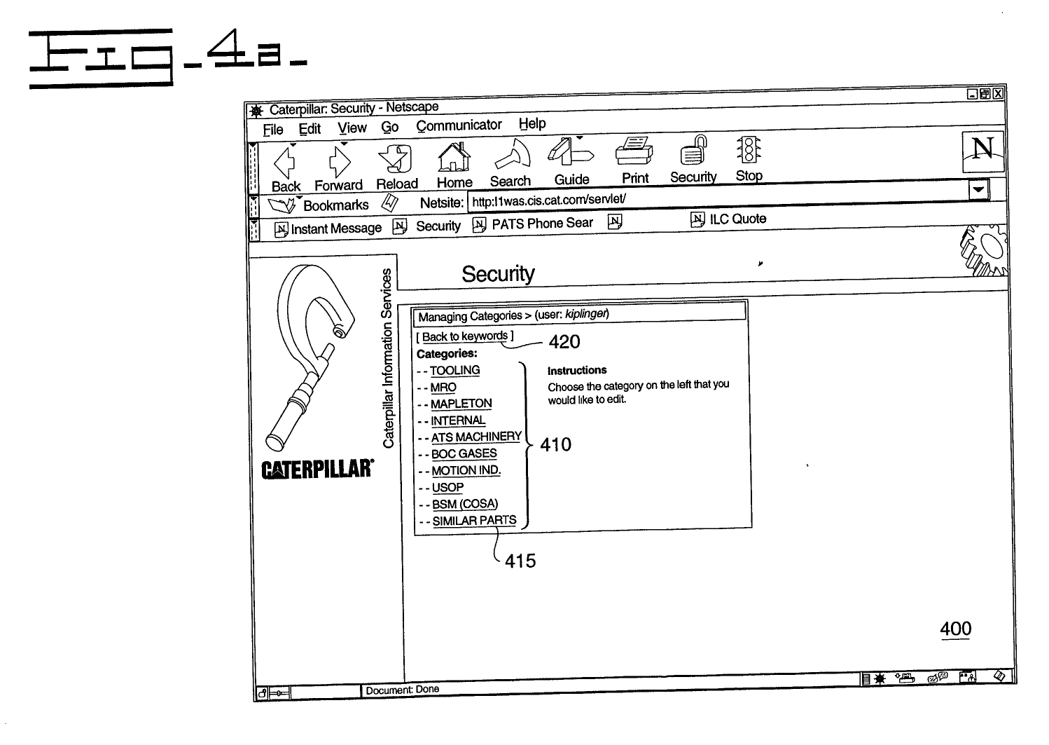

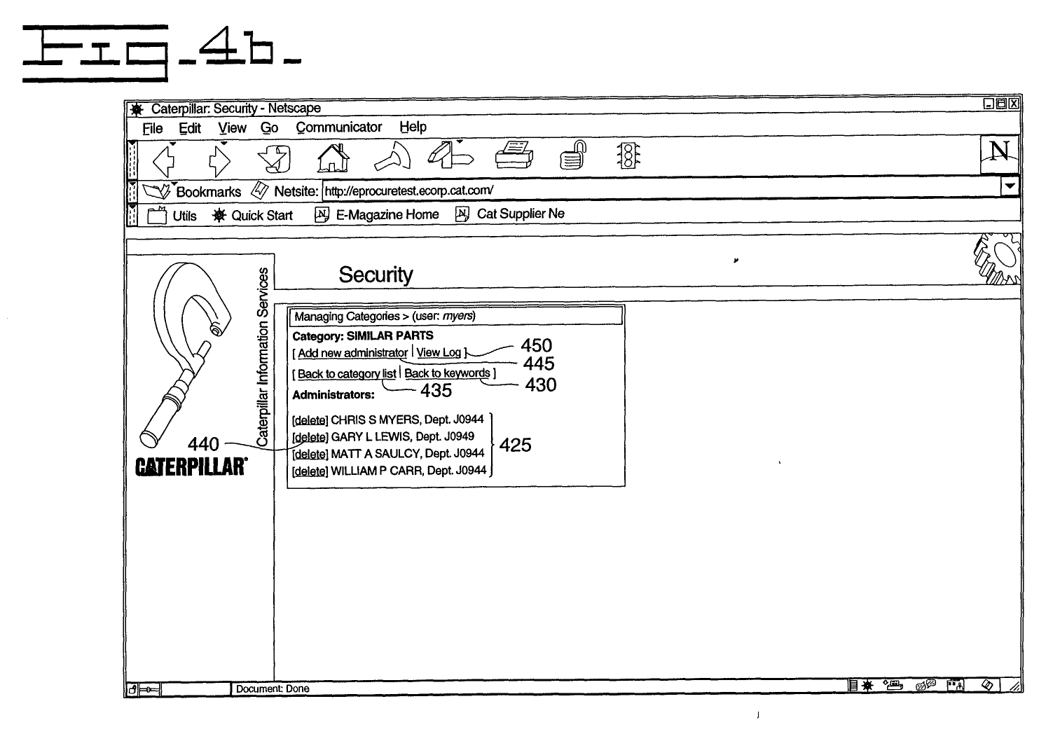

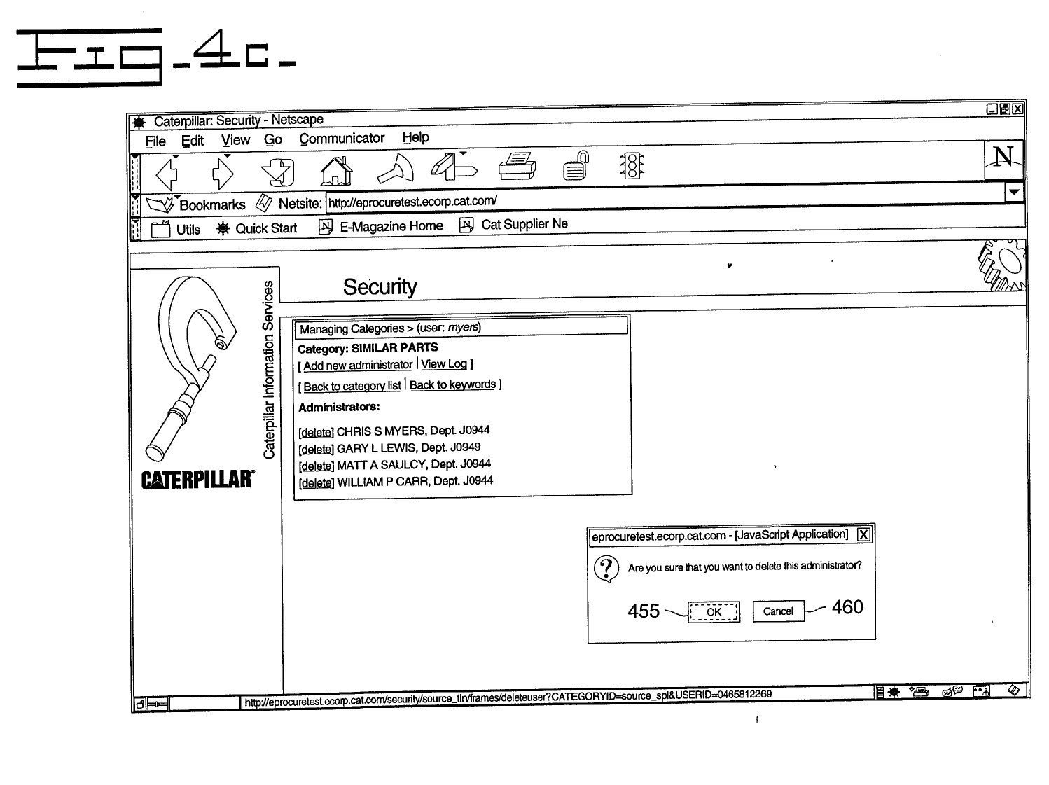

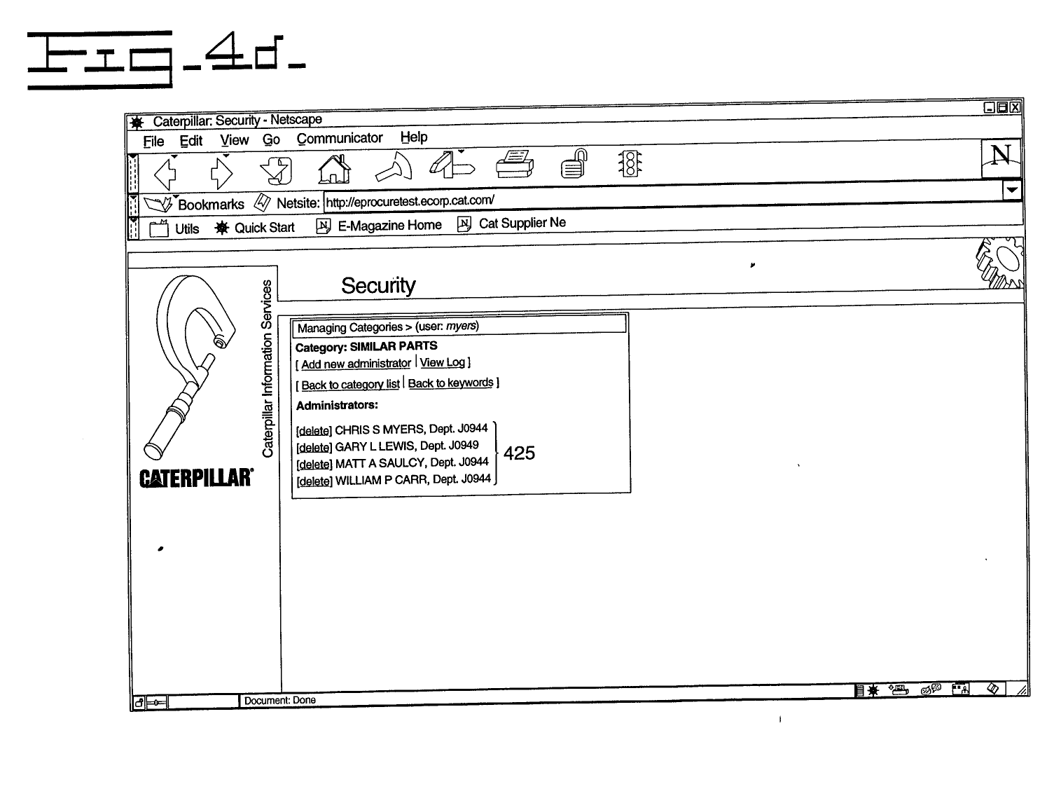

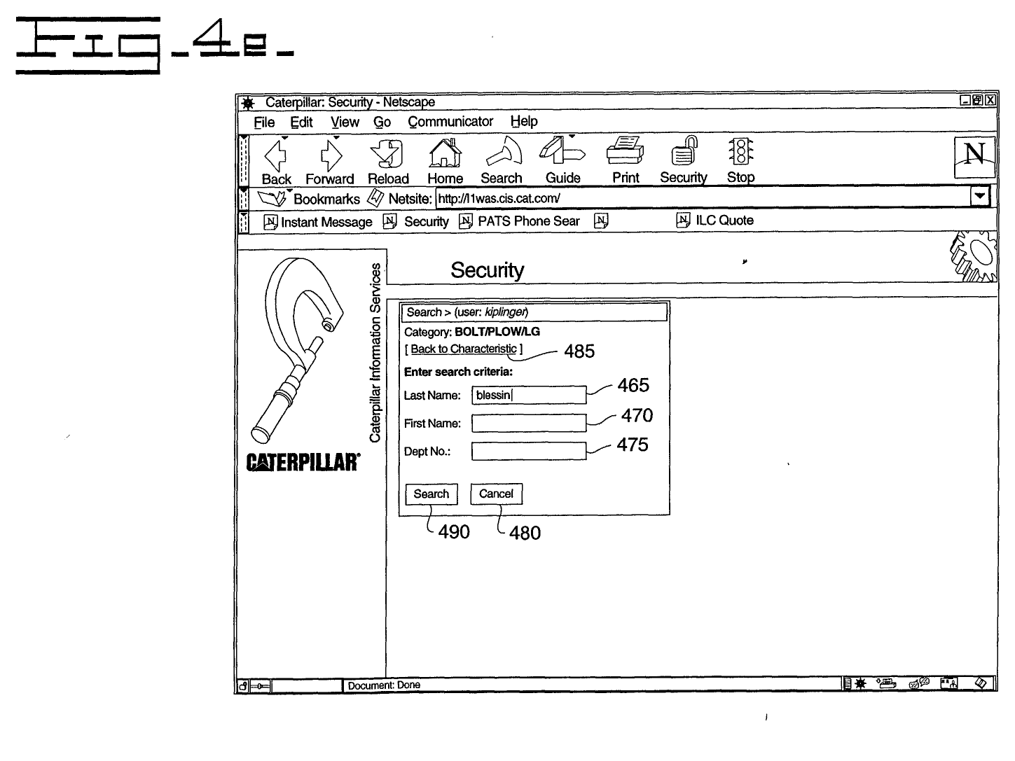

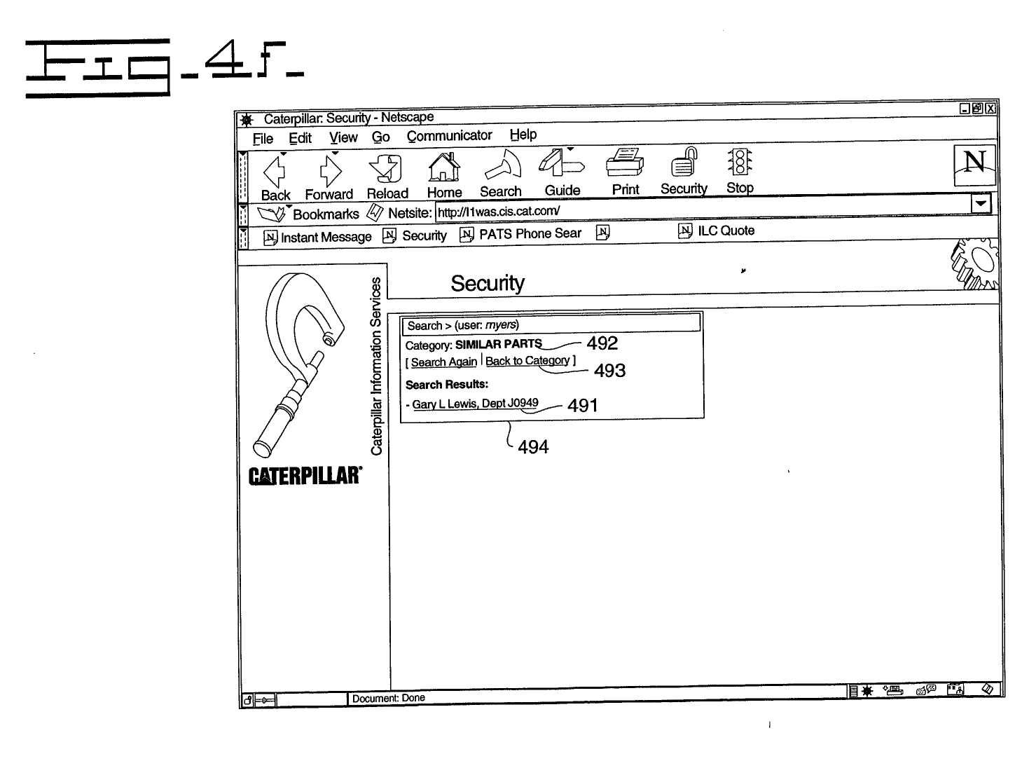

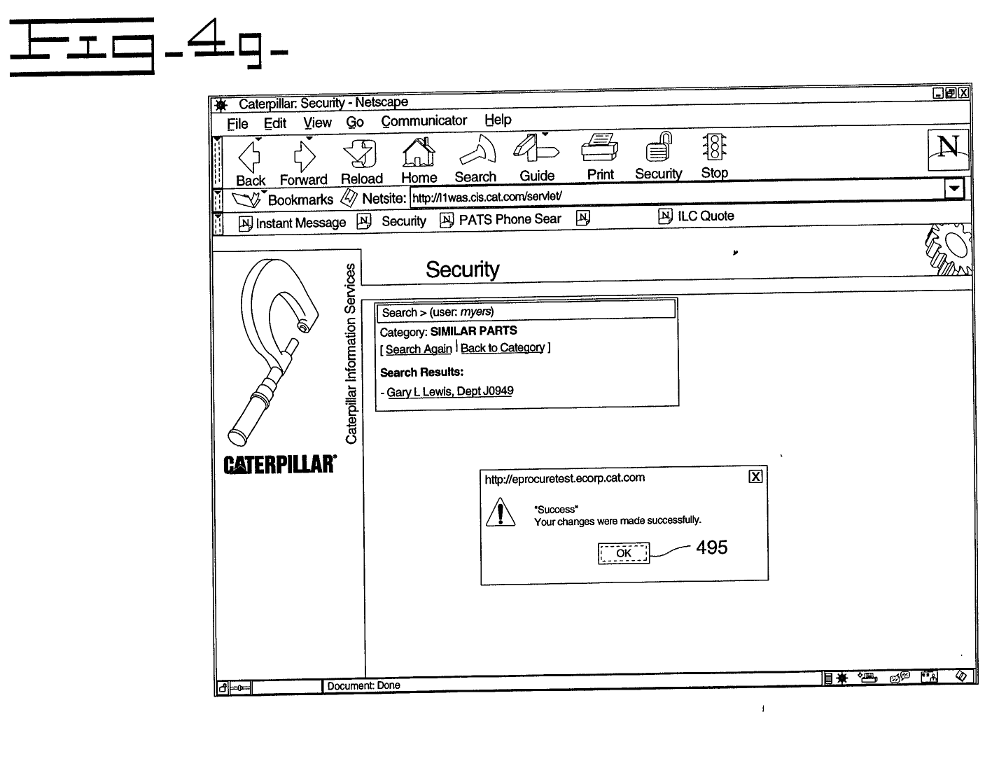

If a super administrator logs in, then the Manage Categories link 340 will appear to him, as shown in FIG. 3B. This link will allow a super administrator to select which users will become administrators of catalogs, and of what catalogs they will have such a power in. If just a regular administrator logs in, then the Manage Categories link 340 will not be available to him as generally depicted by numeral 304 in FIG. 3C. Clicking the Manage Categories link 340, as shown in FIGS. 4A and 4B, will bring up the screen generally indicated by numeral 400 in FIG. 4A. The super administrator is presented with a list of all catalogs 410 in the system to choose from. The choice of a catalog i.e. Similar Parts 415, from this list will allow the super administrator to add or delete users to that particular catalog. The super administrator also has an opportunity to go back to FIG. 3A screen by clicking the Back to keywords link 420. Clicking the Similar Parts link 415 will lead to the display of FIG. 4B. The super administrator now is able to add or delete administrators to the Similar Parts catalog from this screen. This window contains a list of the current users who have administrative status in this catalog 425. The super administrator also has an opportunity to go back to FIG. 3A screen by clicking the Back to keywords link 430, or FIG. 4A screen by clicking the Back to category list link 435. To remove an administrator, the super administrator needs to click the delete link 440 next to the administrator he wishes to delete. In this case, the super administrator wishes to delete Gary. L. Lewis and thus selects the delete link 440 next to his name. The administrator then is presented with the dialog box shown in FIG. 4C. The administrator is then asked if he wishes to delete the administrator. He has the option of clicking OK 455 or cancel 460. If the administrator clicks cancel 460, then he is brought back to the screen in FIG. 4B. If the administrator clicks the OK 455 button, then the screen shown in FIG. 4D appears. Since Mr. Lewis is no longer listed as an administrator in the administrator list 425, he no longer has administrative ability in the Similar Parts catalog.

To add an administrator the user will click the Add new administrator link 445 in FIG. 4B. The screen shown in FIG. 4E then appears. The administrator then can search for a user of the system whom he wants to giver administrator power. The administrator can search by entering a last name in the Last Name field 465, by first name by entering a name in the First Name field 470, by department number by entering a department number in the Dept No. field 475, or any combination of the three. If the administrator wishes to go back to the previous screen, FIG. 4B, he can press the Cancel button 480. The administrator could also click the Back to category link 485 if he didn't want to deal with administrators anymore, and be sent to FIG. 4A. After the administrator enters in the appropriate search criteria, in this case Gary Lewis, he can select the Search button 490 and the screen shown in FIG. 4F then appears. This screen lists all of the matches of the previous search criteria entered 491. In this case there was only one match with a last name of Lewis and first name of Gary. The administrator now can search again if he is unsatisfied with the results by clicking the search again link 492 which will bring back up FIG. 4E. He can also click the Back to Category link 493 if he didn't want to deal with administrators anymore, and be sent to FIG. 4A. If the name of the person he wants to be the administrator appears, the administrator can then click the persons name i.e. Gary L Lewis 494 and the screen shown in FIG. 19G then appears. A dialog box is displayed to the administrator indicating that the selection of the administrator was successful. The administrator must then click the OK button 495 and is sent back to The screen shown in FIG. 4B.

The administrator can also view a log of the previous activity by clicking the View Log link 445 in FIG. 4B. The details of the log are discussed below.

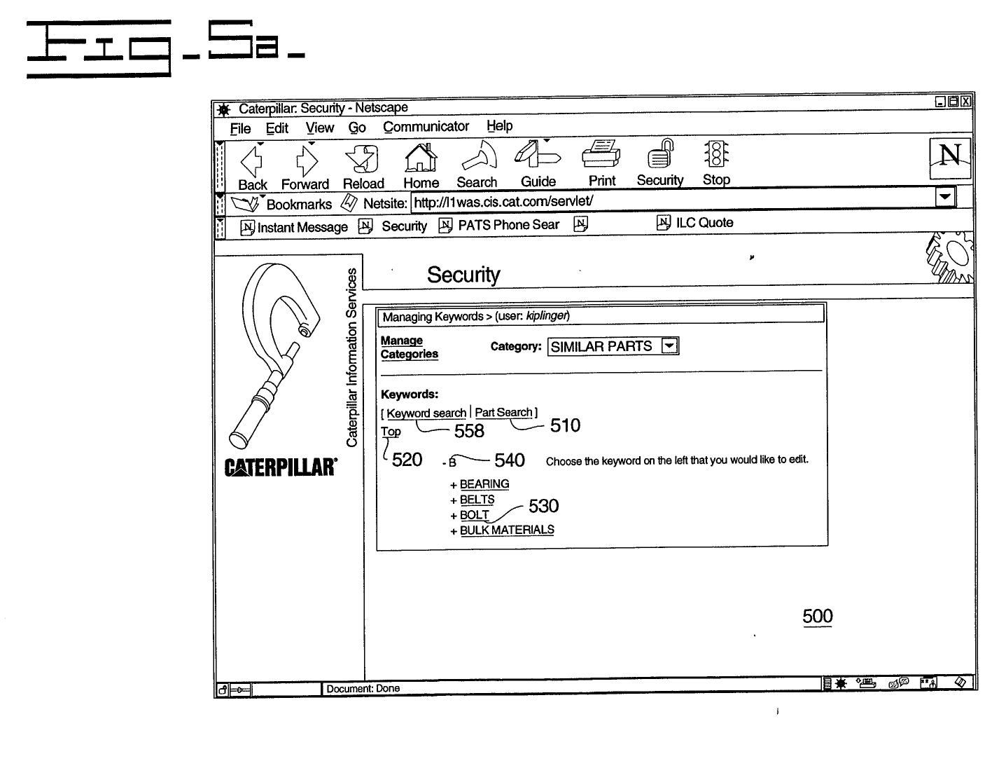

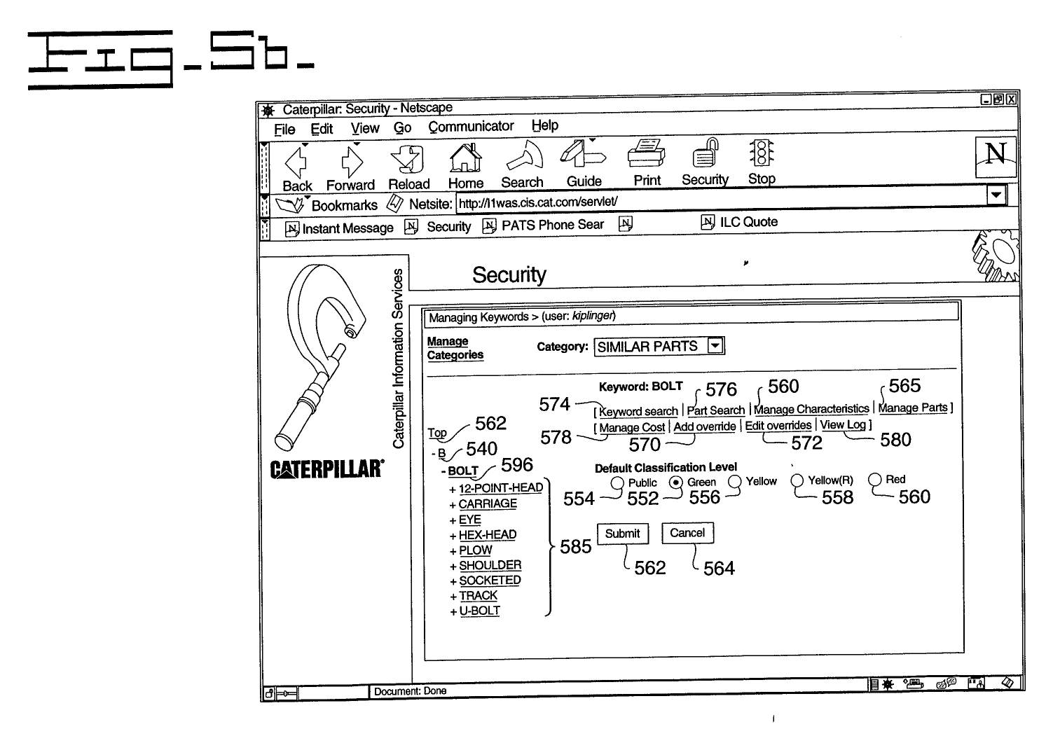

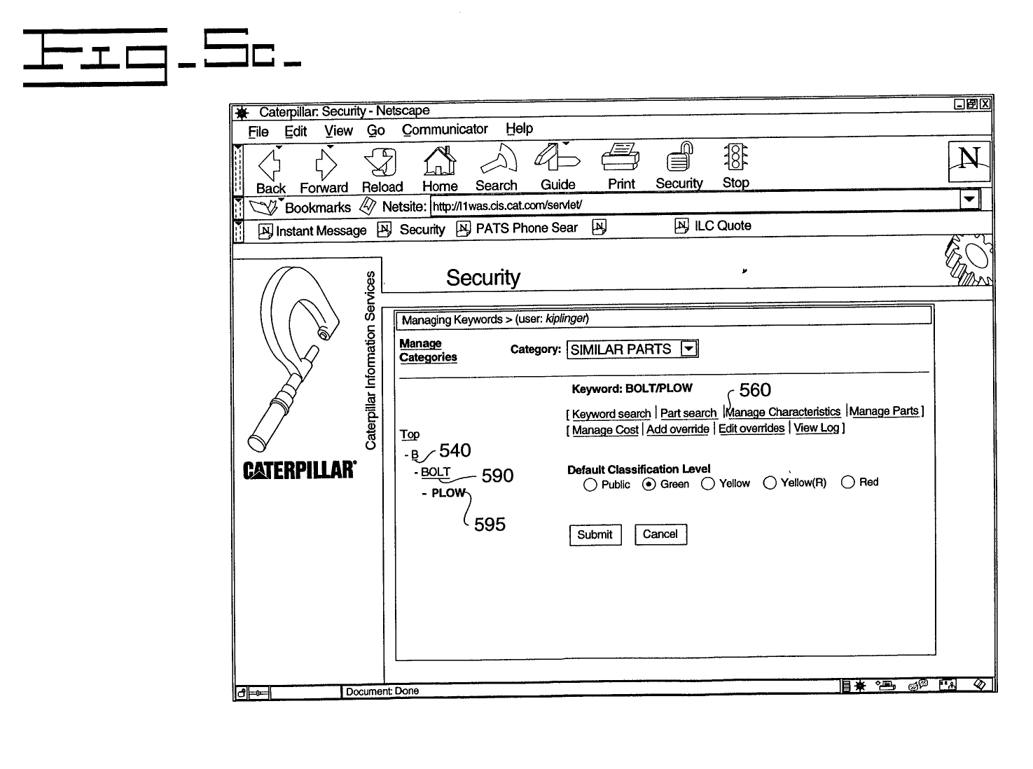

Back to the initial screen FIG. 3A, the administrator is initially presented with the option of simply choosing a keyword of which to administer from keywords sorted in alphabetical folders 315. The administrator can also click the keyword search link 325, part search link 335 or manage cost link 345 all which are discussed below. The selection of a letter like “B” 350 will bring up the screen shown in FIG. 5A. In this screen, all names that begin with “B” 540 are displayed. The administrator also has the option of trying a keyword search or part search if he is unsatisfied with his current search by clicking the keyword search link 550 or part search link 510 respectively. The administrator also has the option of returning to the alphabetical list in FIG. 3A if he clicks the Top link 520. An administrator then selects the first keyword in the name desired from the list 540. Clicking on Bolt 530 will lead to the next screen depicted in FIG. 5B.

There are now many options presented to the administrator starting with this screen. The administrator is presented with the Default Classification Level or security threshold of the Bolt category which in this case is evidenced by the selected radio button next to Green 552. Each security threshold of the first keyword of a name is stored in the classification field of the keyword table. Each possible security threshold is assigned to a number. Public 554 is the most accessible has a security threshold number of 10. Green 552 has a security threshold number of 20. Yellow 556 has a security threshold number of 30. Yellow(R) or Yellow with restrictions 558 has a security threshold number of 35. Finally Red 560 has a security threshold number of 1410. To change the current security threshold of the category Bolt, an administrator simply has to select the appropriate radio button next to the security threshold desired, and click the submit 562 button. If an administrator clicks a different radio button other than the one initially selected when he got to this screen i.e a radio button other than Green, hitting the cancel button 564 will return the radio button back to that original location. If an administrator changes the default security threshold of a piece of data, then the new security threshold will become the new location of the radio button when the cancel button 564 is hit. The change to the security threshold is instantly entered into a security log as will be discussed in detail below. An administrator also has other options on the screen in FIG. 5B such as Manage Characteristics 495, Manage Parts 540, Add Override 570 and Edit Override 572 which will be discussed in detail below.

The administrator also has the option of a keyword search, a part search, or managing costs as will be described below, if he is unsatisfied with his current search by clicking the keyword search link 574, part search link 576 or mange cost link 578 respectively. The administrator also has the option of viewing the log regarding security activity involving the Bolt category by clicking the View Log link 580.

If the administrator doesn't wish to apply security at this level of the catalog, he may continue to narrow his search by clicking a keyword characteristic 594. The keyword characteristics are organized in a tree-like fashion on the side of the screen. The keyword in bold face 590 i.e. BOLT shows the user what level of the tree he is currently at. All of the keywords below the bolded keyword, are branches i.e. more specific categories of that bolded keyword.

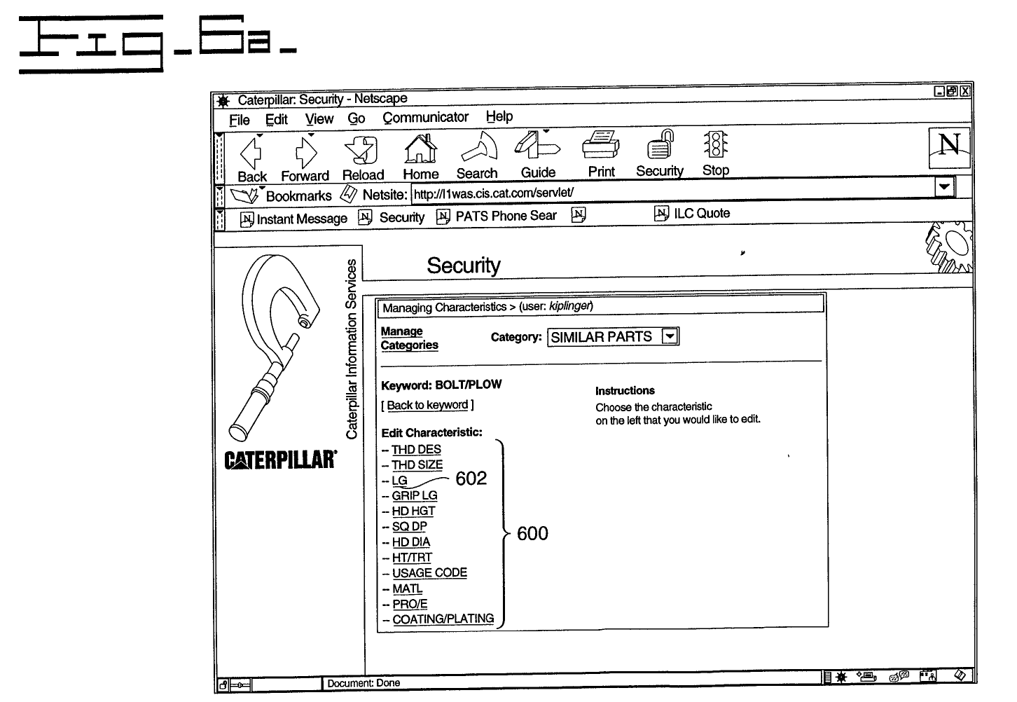

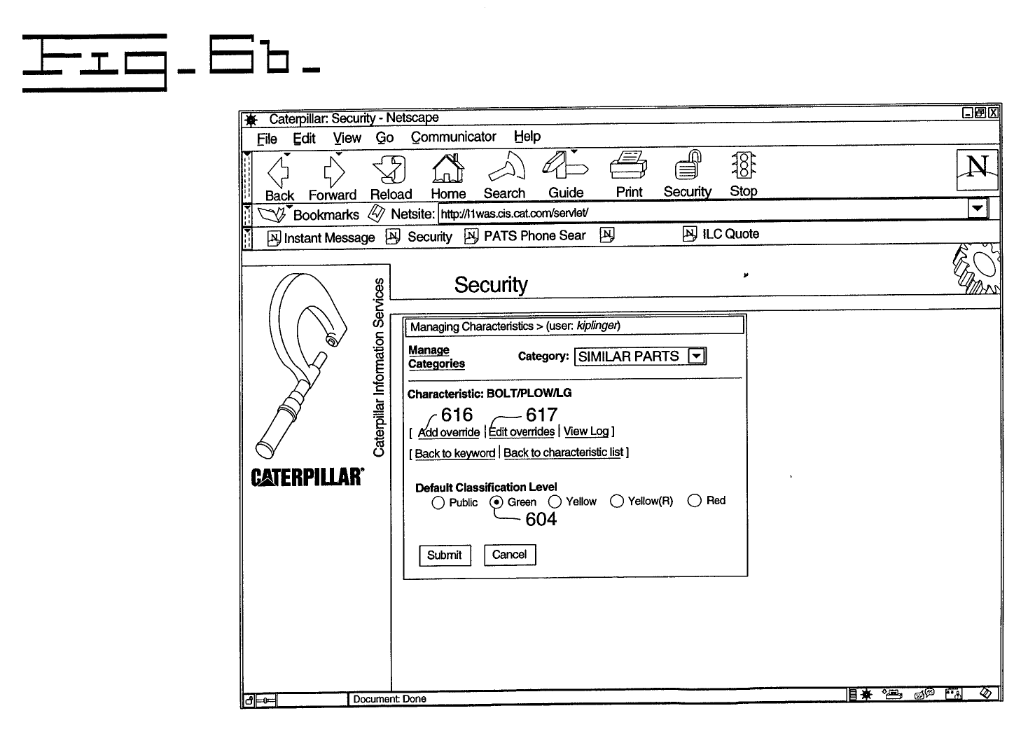

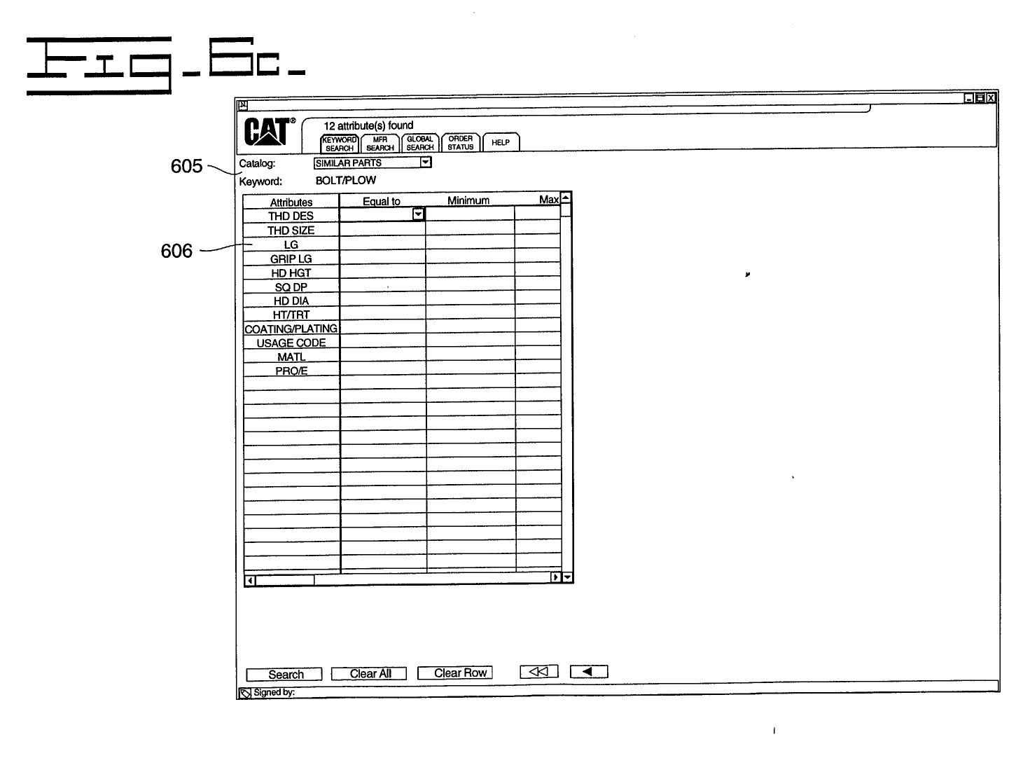

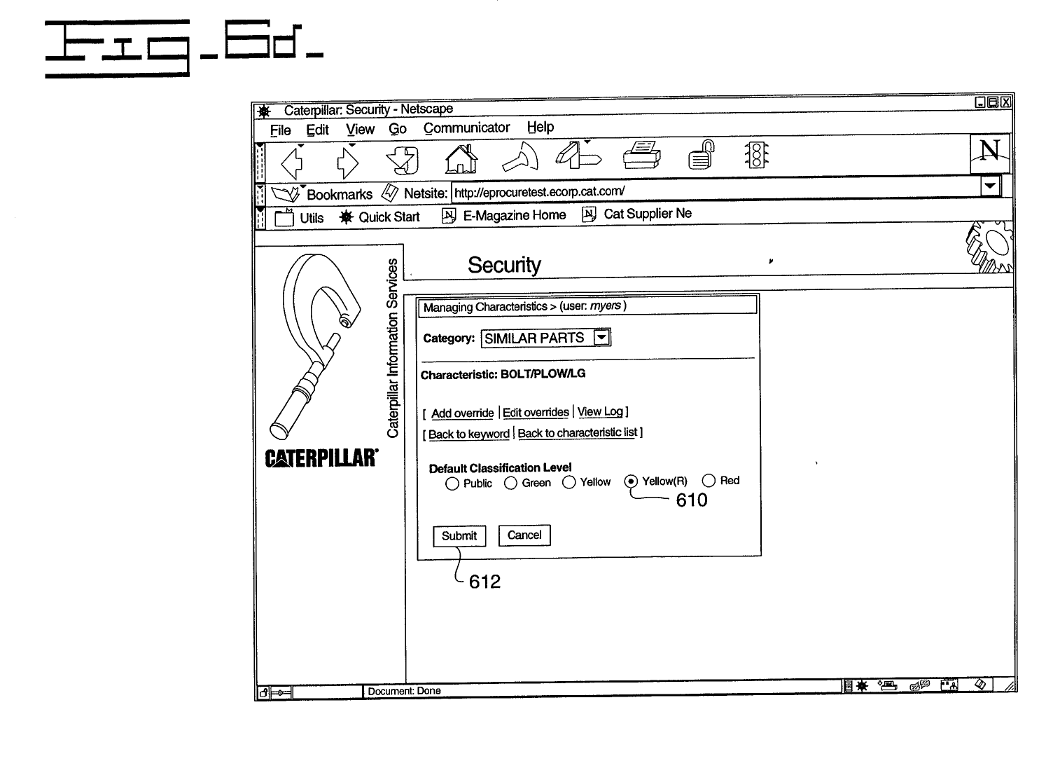

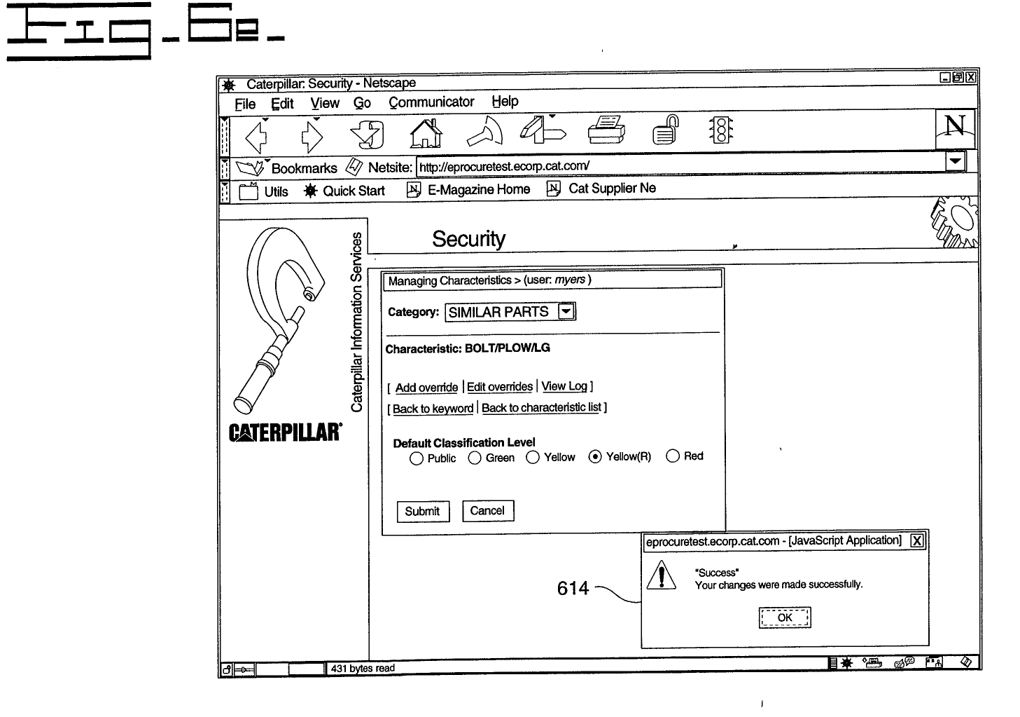

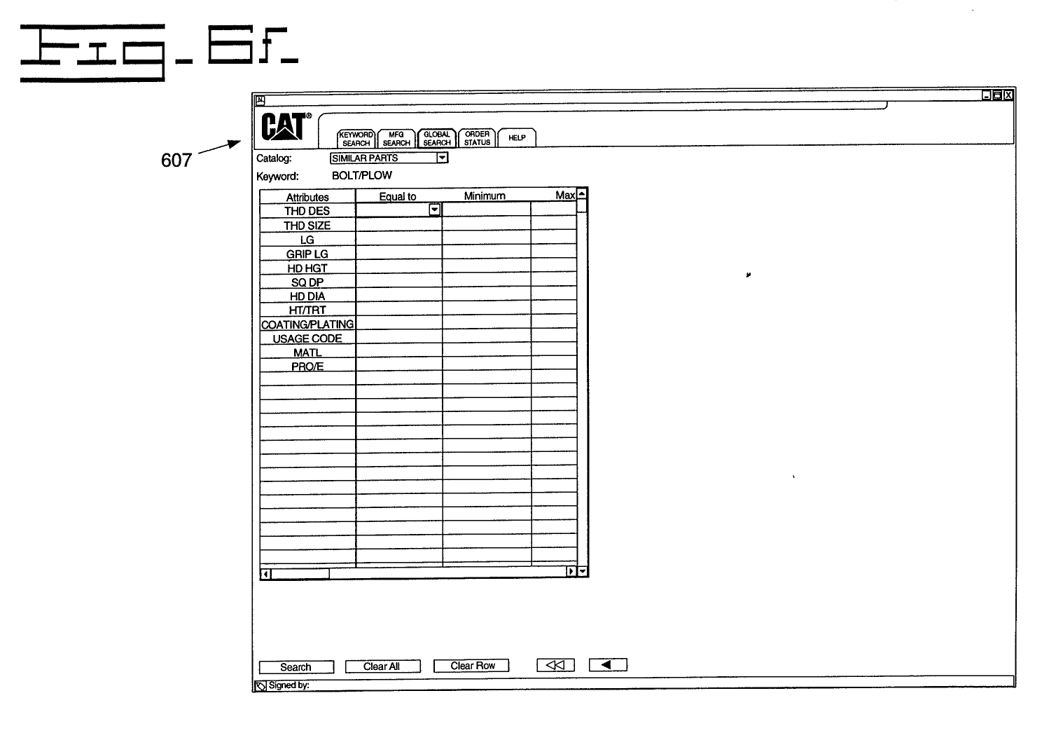

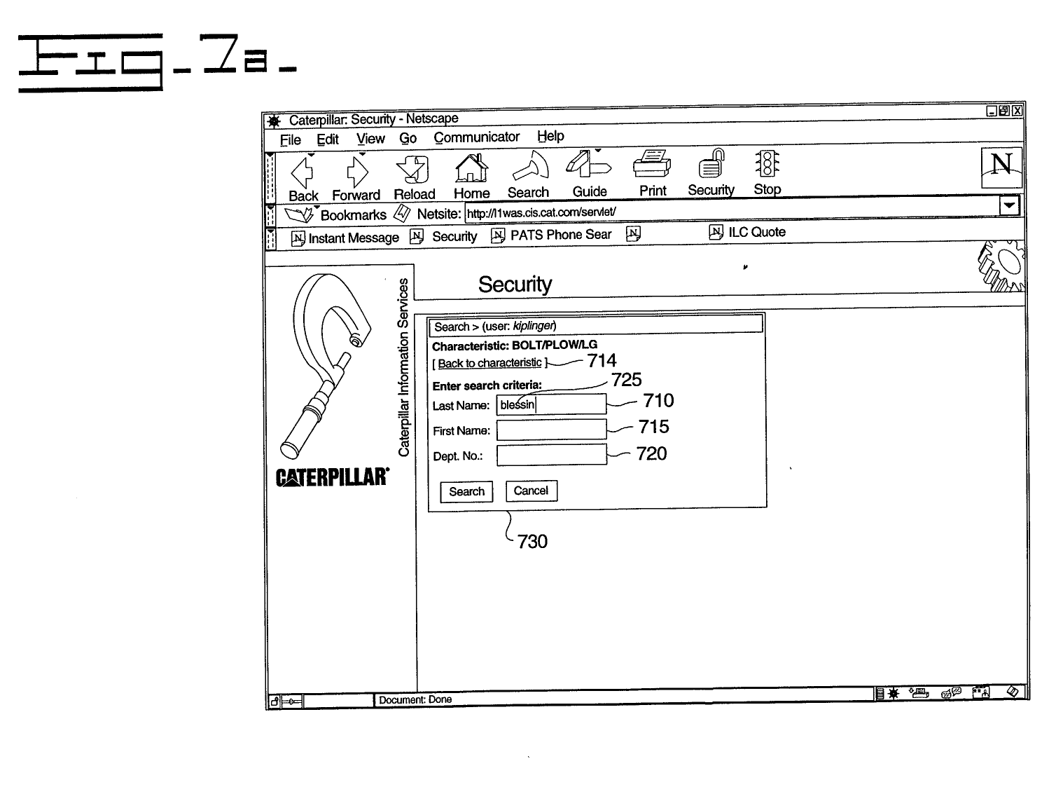

In this case clicking Plow 595 will cause the screen depicted in FIG. 5C to appear. An administrator has virtually the same choices on this screen as he did in the screen depicted in FIG. 5B. One change is that now the administrator is unable to choose any more specific keywords, since Plow 595 is the most specific keyword in this name. When an administrator reaches this point in the keyword search, he may either go back up the tree by clicking the branches above it like Bolt 590, B 540 or Top 520, change the security level of this portion of the tree as described above, or choose the other options previously presented in FIG. 5B. In this case the administrator will click the Manage Characteristics link 560, which will lead to the screen depicted in FIG. 6A.

Manage Characteristics will allow an administrator to change access levels of particular attribute characteristics of a keyword. A list of all attribute characteristics 600 relating to a Plow Bolt is presented to the user. An administrator then can select a particular attribute characteristic that he would like to change the access levels to. In this case an administrator selects LG (length) 602, and the screen depicted in FIG. 6B is displayed.

The administrator can now adjust the security threshold of the attribute characteristic LG with respect to Plow Bolts from its current level Green 604 to any of the other options presented. This is just as described above. Currently, a search by a user with a security threshold Green or higher, will enable a user to see the attribute characteristic LG after specifying search criteria. The LG 606 attribute characteristic is clearly shown in the results of a search, for instance, all plow bolts whose part number equals 3K5802 when the user selects a part 607 he wishes to see more information on.

If the administrator wishes to raise the security level of this attribute characteristic to a higher threshold, he may first click the radio button next to the new security threshold i.e. Yellow(R) 610 as shown in FIG. 6D. The administrator then clicks the Submit button 612, and is shown the dialog box in FIG. 6E. Here the administrator is informed that the change was successful, and must click the OK button 614. FIG. 6D will now be the screen that appears to a user who looks at the characteristic BOLT/PLOW/LG, as opposed to FIG. 6B as was the case before the security threshold change. Since the administrator now chose a security threshold higher than the current users security level, the user doing the same search as above will not be able to see the LG attribute characteristic when he selects a part 607 as he was able to before. This is shown in FIG. 6F. This is unlike the screen the user was able to see before in FIG. 6C.

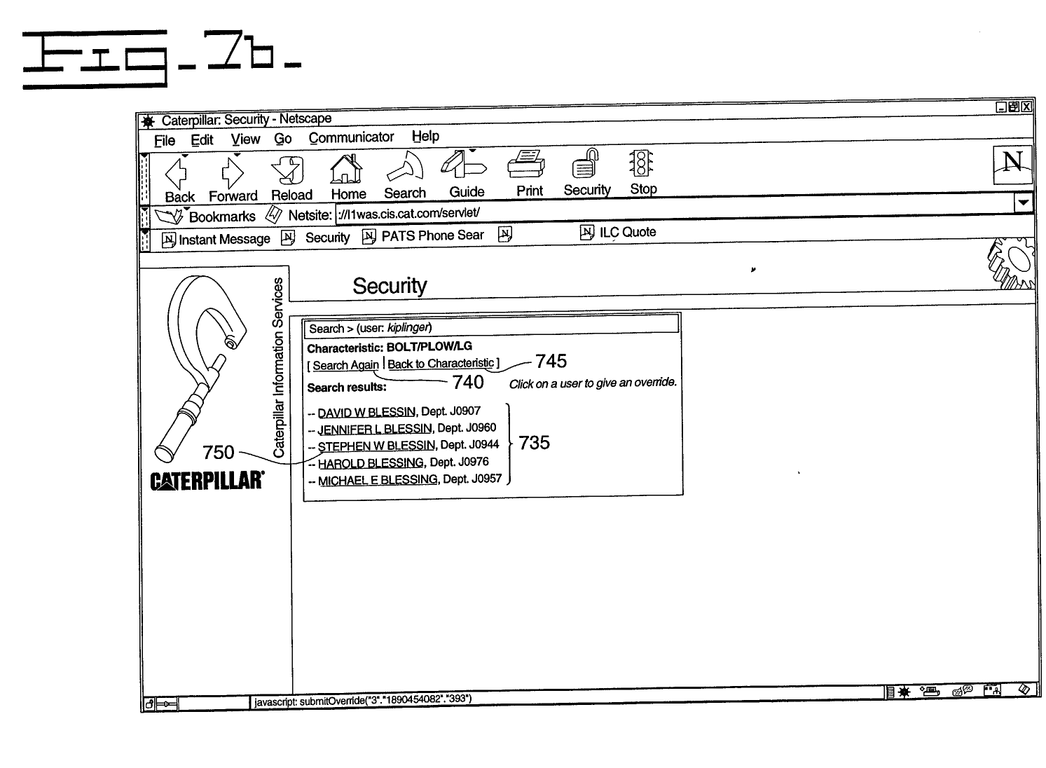

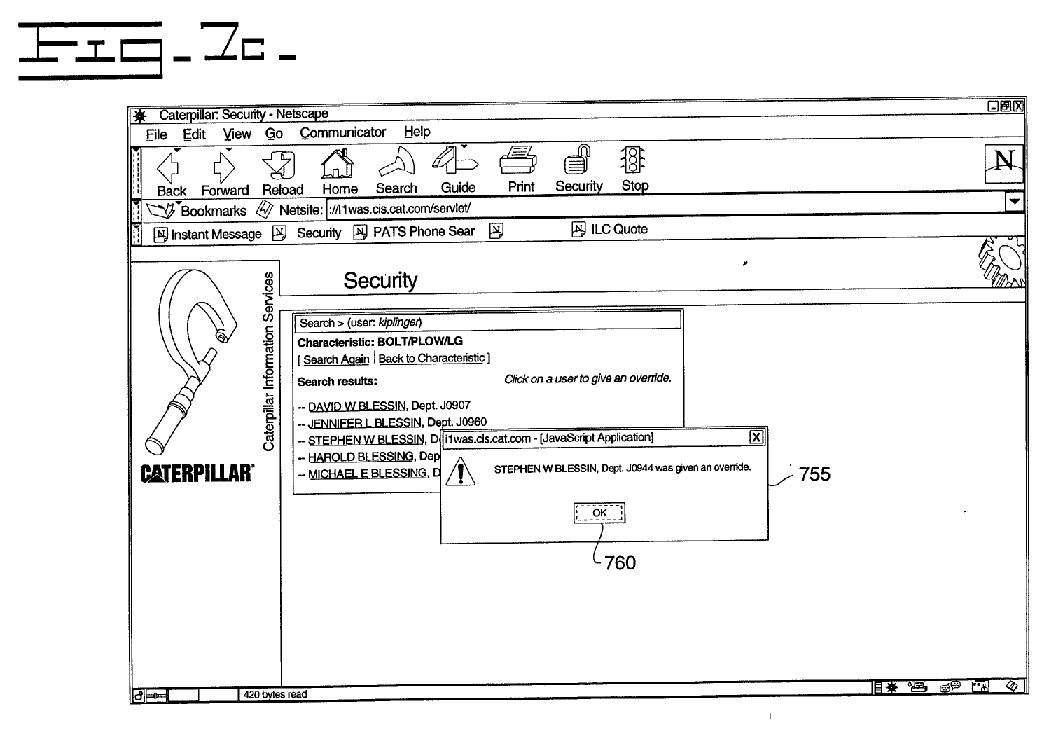

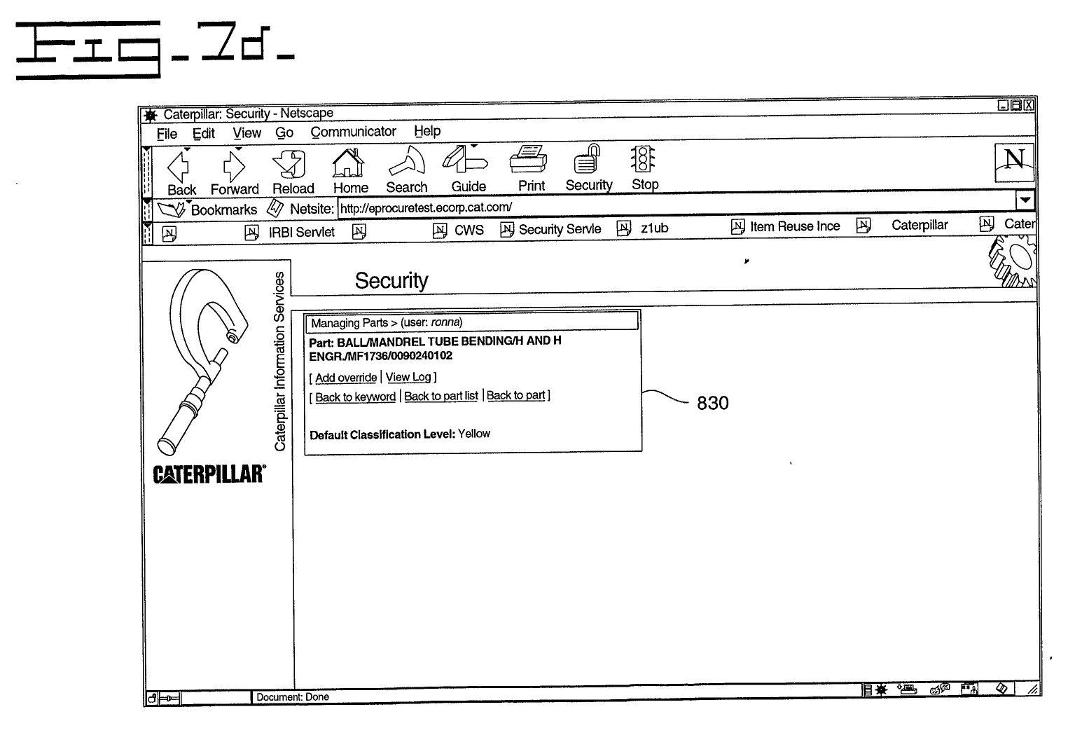

An administrator has the option of allowing an override to this particular attribute characteristic of a particular keyword or name i.e. Plow Bolt, for a particular user. An override is a temporary adjustment to the security level of a particular user with respect to a particular security threshold of either a keyword, a keyword characteristic or part. To accomplish this the administrator clicks the Add Override link 616 in FIG. 6B and is taken to the screen shown in FIG. 7A.

The administrator then has the option of searching for an employee or user, by last name 710, first name 715 or Department Number 720. In this case the administrator has entered Blessin 725 in the last name field 710. When the administrator selects the search button 730, the screen shown in FIG. 7B appears.

The administrator is now given a list of users 735 that have the last name Blessin. The administrator also has the option of trying a search again by clicking the Search Again link 740, which will take him back to the screen in FIG. 7A. The administrator also has the option of clicking the Back to characteristic link 714, which will bring him back to managing characteristics screen FIG. 6D. The administrator now can select a name, in this case Stephen W Blessin. The person whom the administrator chooses, is the one whom the administrator intends to give an override to. The selection causes the screen in FIG. 7C to appear. The user is then informed in a dialog box 755 on this screen that the selection made of the user in FIG. 7B Stephen W Blessin has been given an override. The administrator then selects the OK button 760, and is brought back to the screen depicted in FIG. 6D.

The result of the above override will allow Stephen W Blessin to see the LG attribute characteristic LG 606 when looking at the results of a Plow Bolt search, as previously shown in FIG. 6C.

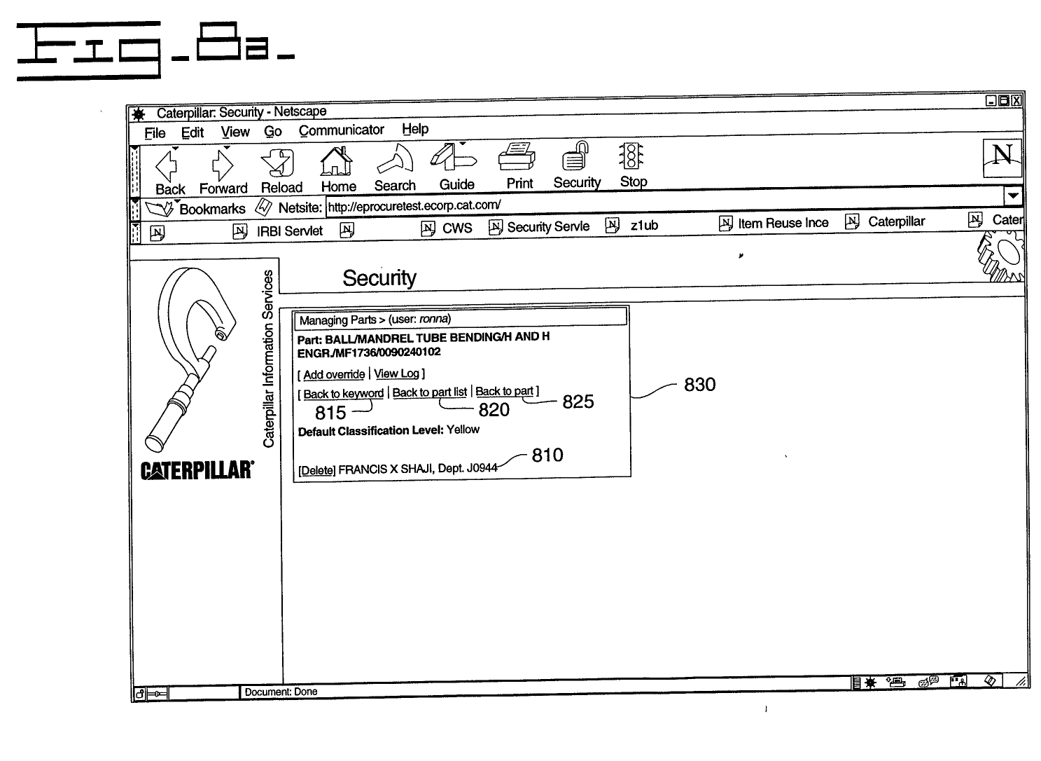

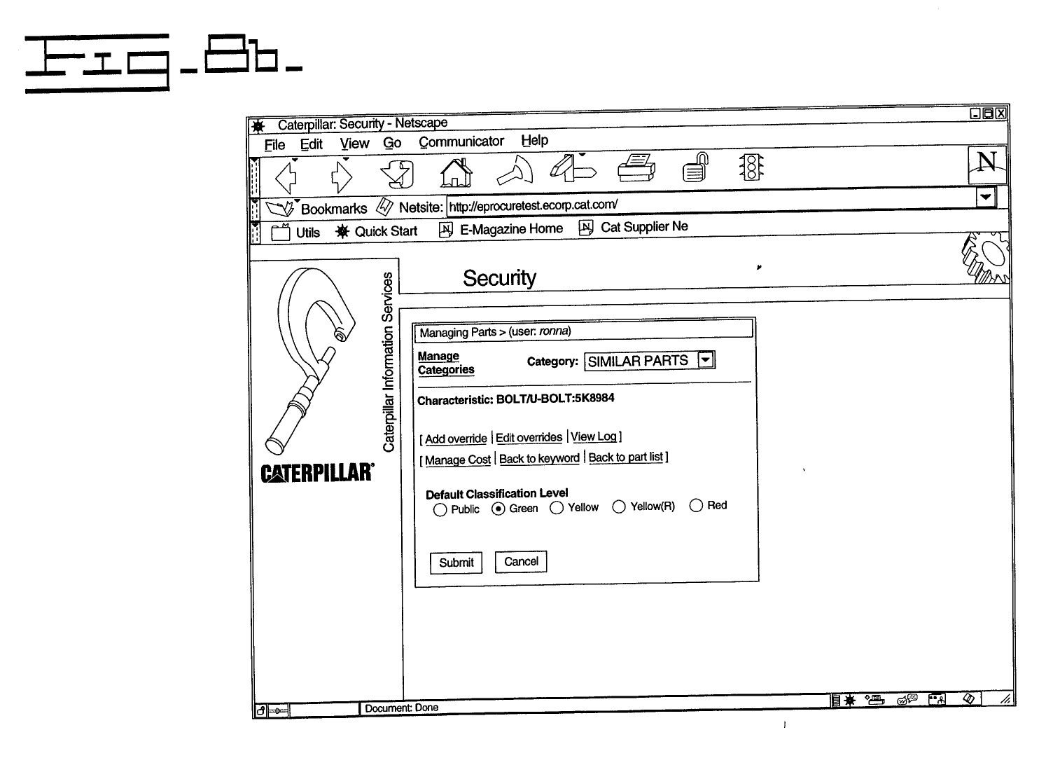

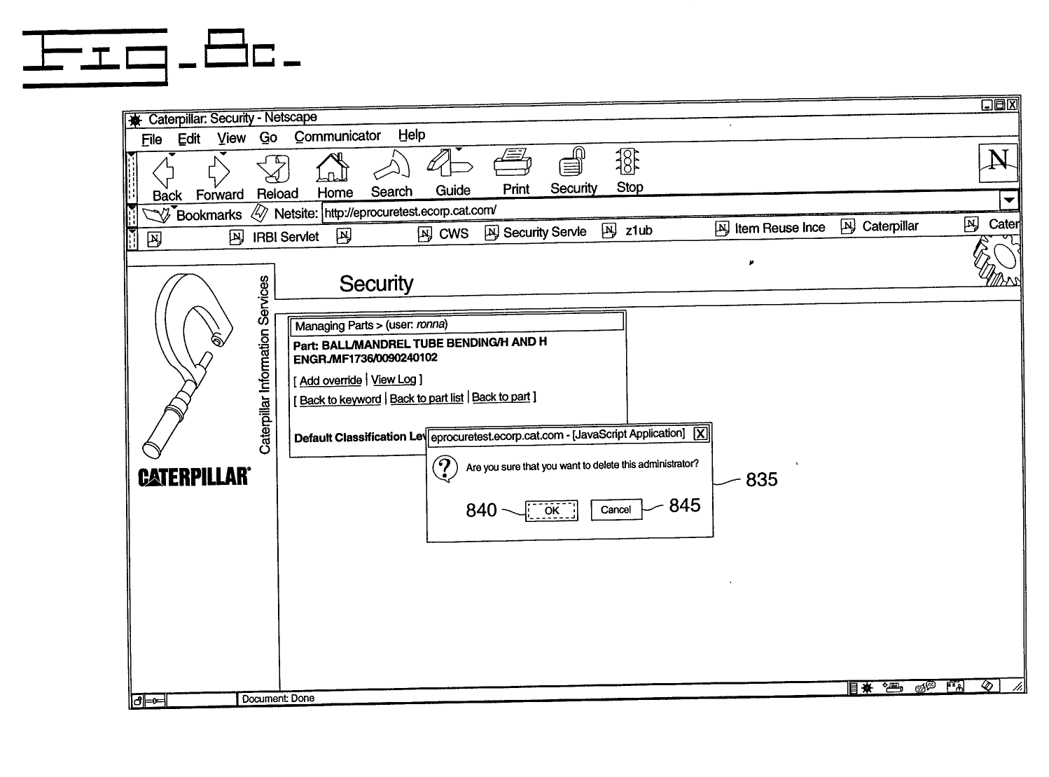

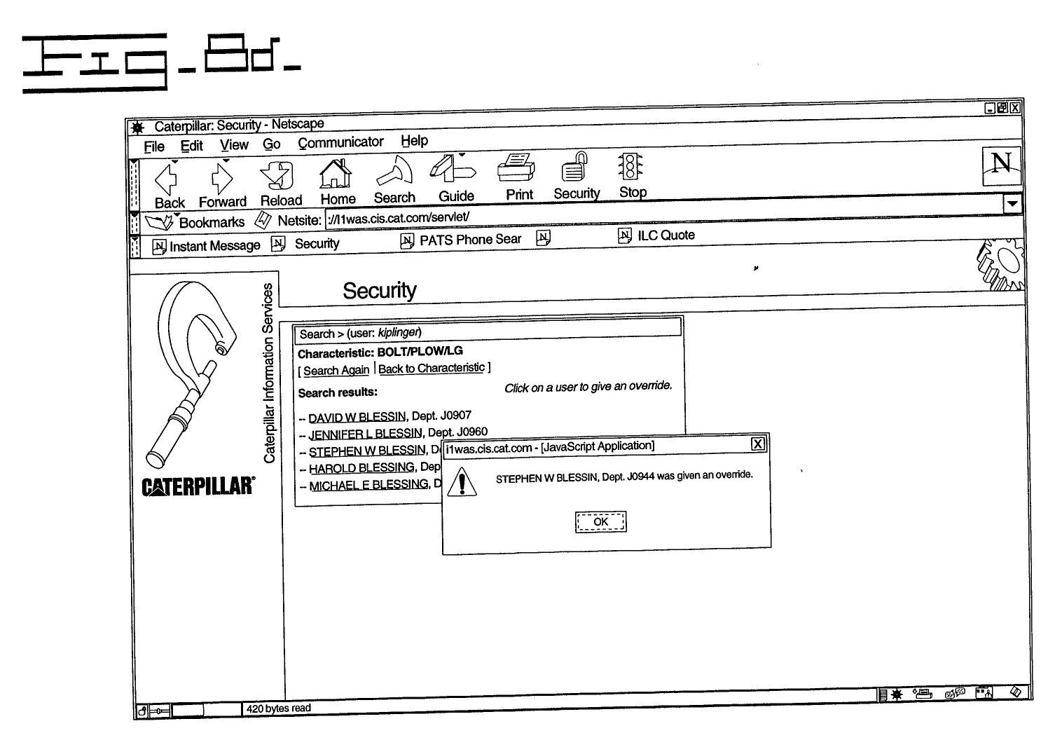

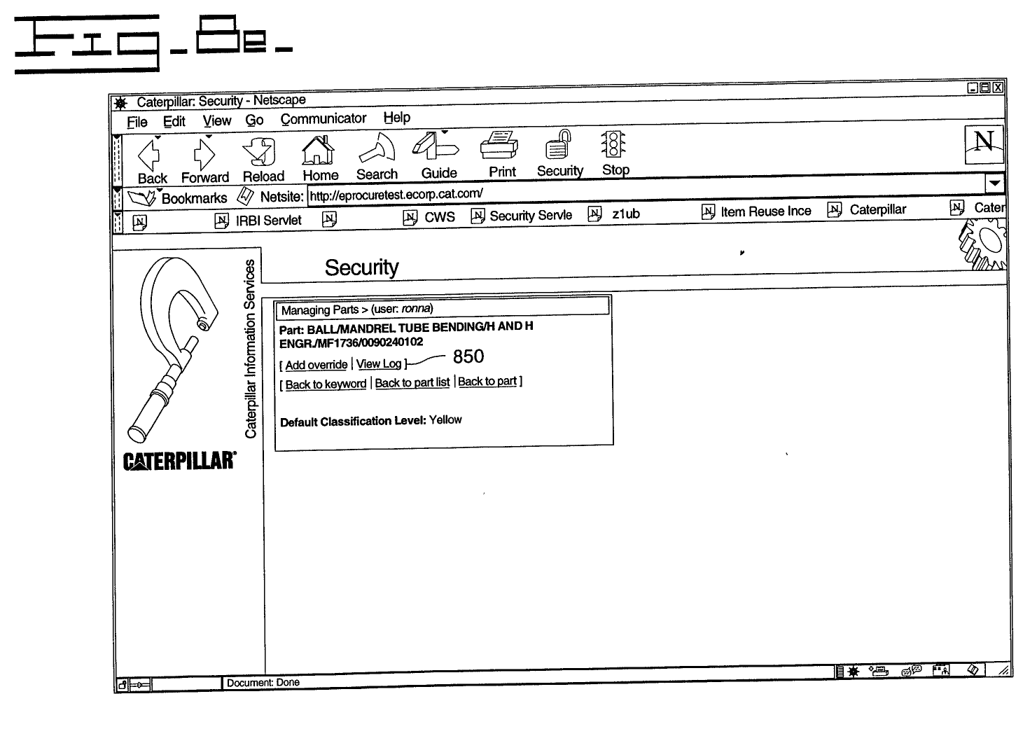

If an administrator instead chooses to remove or change an override, the administrator would select the Edit Overrides link 617 in FIG. 6B. This leads to screen shown in FIG. 8A to appear.

The administrator is shown all of the users 810 who currently have overrides with respect to this part number. The user has the option to go back to the keyword screen for this part FIG. 5C by clicking the Back to Keyword 815 link, back to the part screen such as FIG. 8B, by clicking the Back to Part link 825, or back to the part list screen such as FIG. 6C, by clicking the Back to Part List link 820.

To delete an override for a particular user, the administrator needs to click the Delete link 830 next to the name of the person he no longer wants to have an override. In this case the user selected the Delete link next to Stephen W Blessin, and the screen shown in FIG. 8C appeared. The administrator is now confronted with a dialog box 835 with two choices OK 840 and Cancel 845. If the administrator doesn't wish to delete the override, he may hit the Cancel button 845, and is taken back to FIG. 8C, If the administrator does wish to continue, he clicks the OK button 840, and FIG. 8D appears. The user is then told by a dialog box 850 that the changes were made, and the user must hit the OK button 855 and is taken to FIG. 8E, which shows the same thing as FIG. 8A except that Stephen W Blessin, no longer is displayed as having an override for this particular attribute characteristic.

Thus, now when Stephen W Blessin searches for a Plow Bolt, he will not see the LG attribute characteristic, as shown in FIG. 6F. An administrator can then select the View Log link 850 in FIG. 8E just like in any of the other screens, to see all of the changes that have been made.

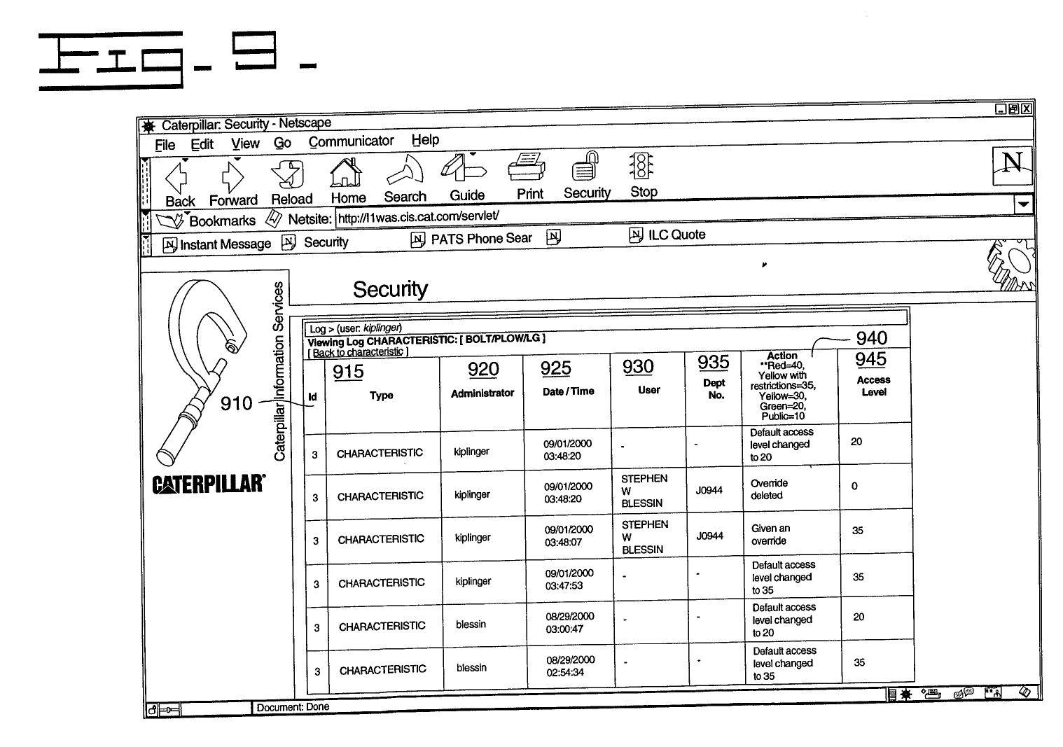

That selection will lead to FIG. 9. The log is used to keep track of all security level or threshold changes. Eight different pieces of information are stored for each transaction. First an ID field 910 that uniquely identifies a individual log (primary key). Next, a type field 915 that contains what kind of parcel of data's security threshold was changed Characteristic, Keyword, Part or Price. Then an administrator field 920 that contains which administrator was responsible for the changes in security. Then a date and time field 925 the change in security happened. Then if necessary a user field 930 that will show which user was affected by an override. Then a department number field 935 that contains what department that user is in. Then an Action field 940 describing what kind of security change was done. This would be either an override given, or deleted, or the changing of the default access level of a keyword, keyword characteristic, part or price. Finally, an access level field 945 that contains what the security level of whatever was changed currently is.

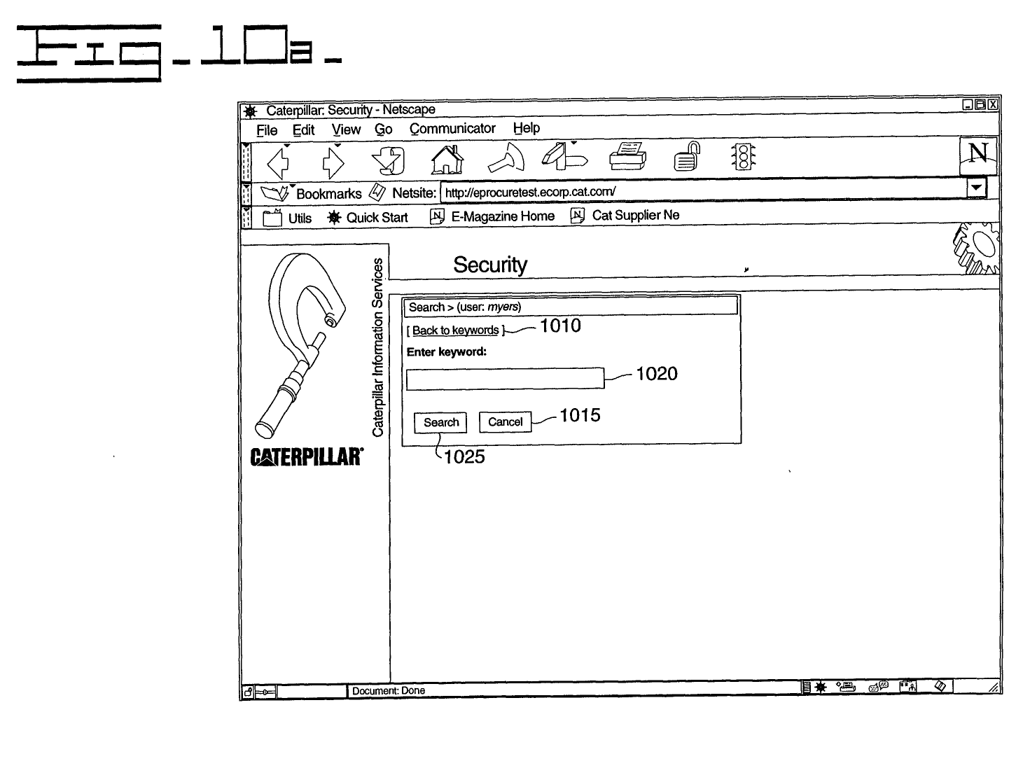

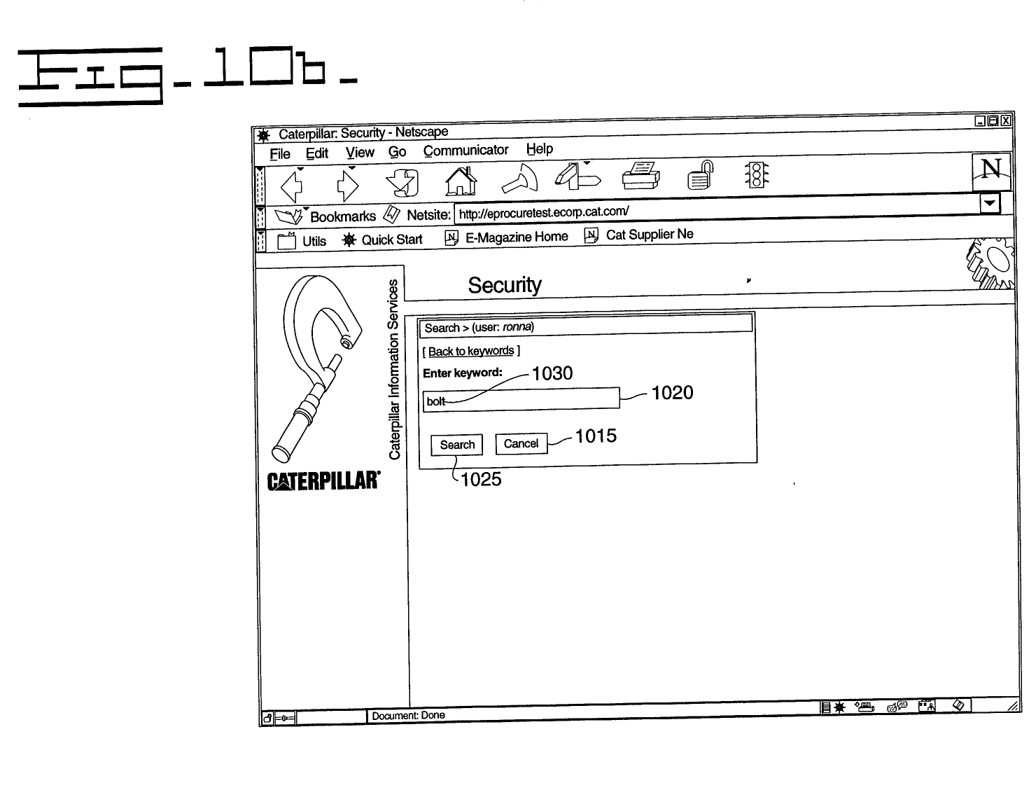

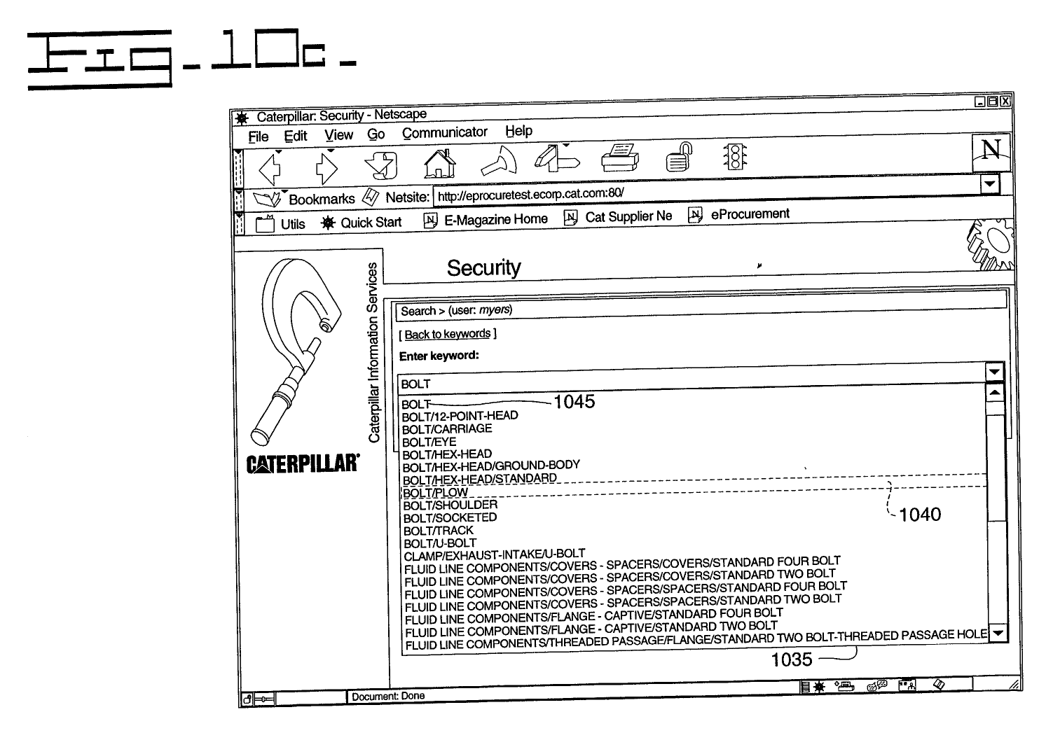

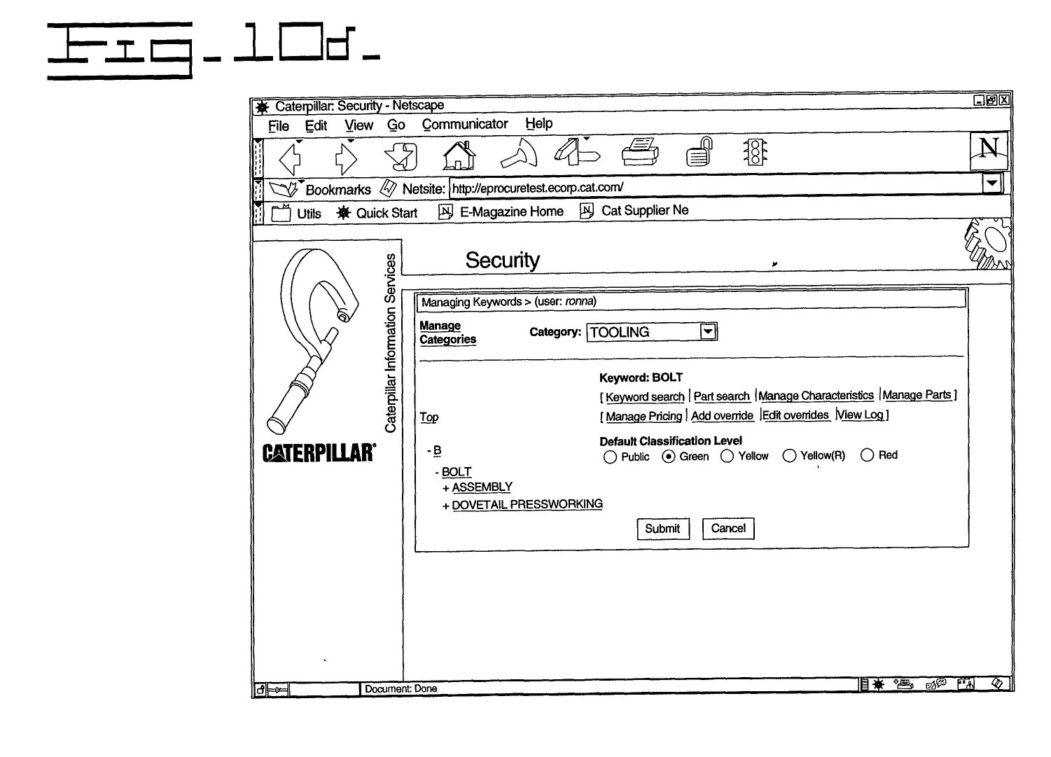

Back to FIG. 3A, the administrator had other options to search for a particular keyword or part. The administrator could have searched for a keyword by selecting the keyword search link 325 which would bring up the screen shown in FIG. 10A. The administrator now has the option of clicking the back to keywords link 1010 which will bring the user back to FIG. 3A. The administrator also could click the Cancel button 1015 which will bring the administrator back to the screen from which he clicked a keyword search link. The administrator can continue searching for a keyword by entering in a keyword (bolt) 1030 in the keyword entry field 1020, as shown in FIG. 10B. In this case the administrator is searching for a bolt. Pressing the submit button 1025 will lead to FIG. 10C. The administrator is now shown a drop down box 1035 and a list of all keywords 1040 that contain the word bolt. The administrator then can select a keyword he is searching for in this case bolt 1045, and the screen shown in FIG. 10D appears. This screen is the keyword screen just like back in FIG. 5B (except for a different catalog). All of the options are the same as the discussion of FIG. 5B above.

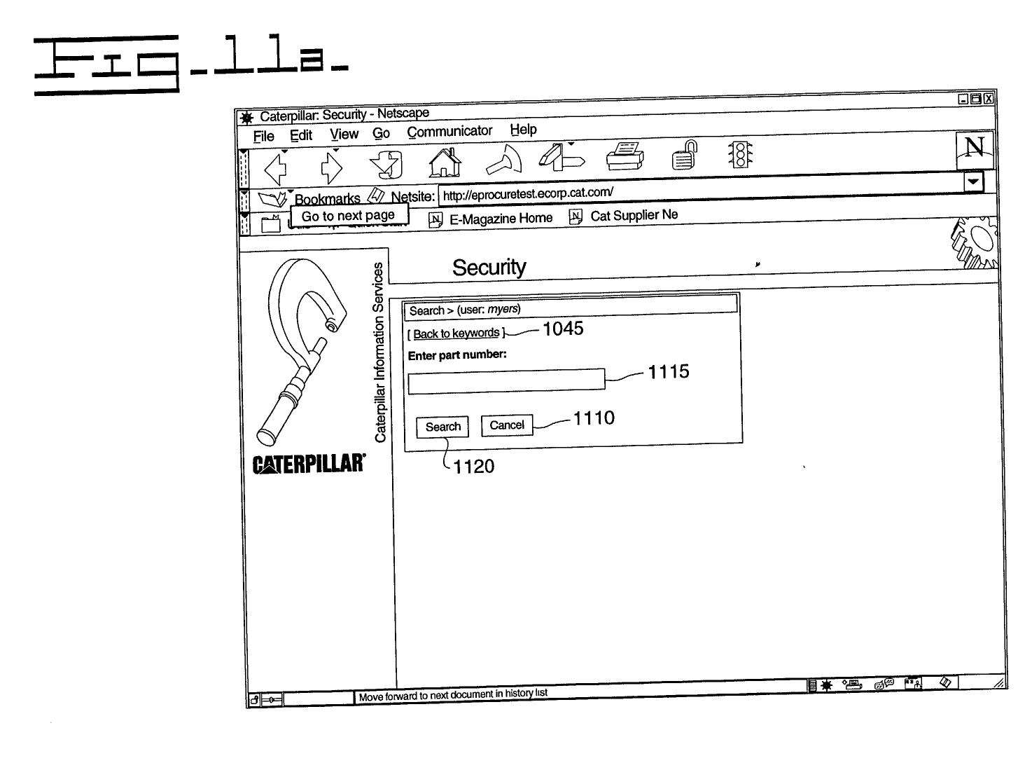

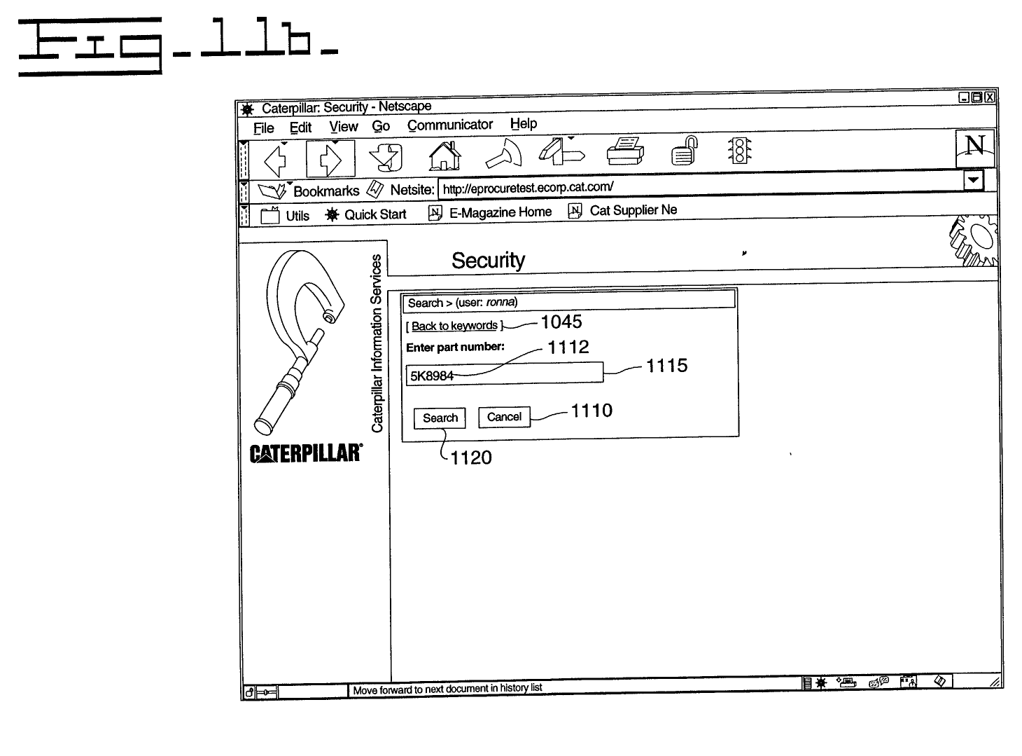

Again in FIG. 3A, the administrator had an option of a part search by clicking the part search link 335. This would lead to the screen in FIG. 11A appearing. The administrator again has the option of clicking the back to keywords link 1045 which will bring the user back to FIG. 3A. The administrator also could click the Cancel button 1110 which will bring the administrator back to the screen from which he clicked a part search link. The administrator can continue searching for a part by entering in a part number 1112 in the part number entry field 1115, as shown in FIG. 11B. In this case the administrator is searching for part number 5K8984. Pressing the submit button 1120 will lead to FIG. 8B. This screen is similar to the screen shown in FIG. 6B {21B} except that it deals with the particular part 5K8984 which is a U-Bolt kind of bolt.

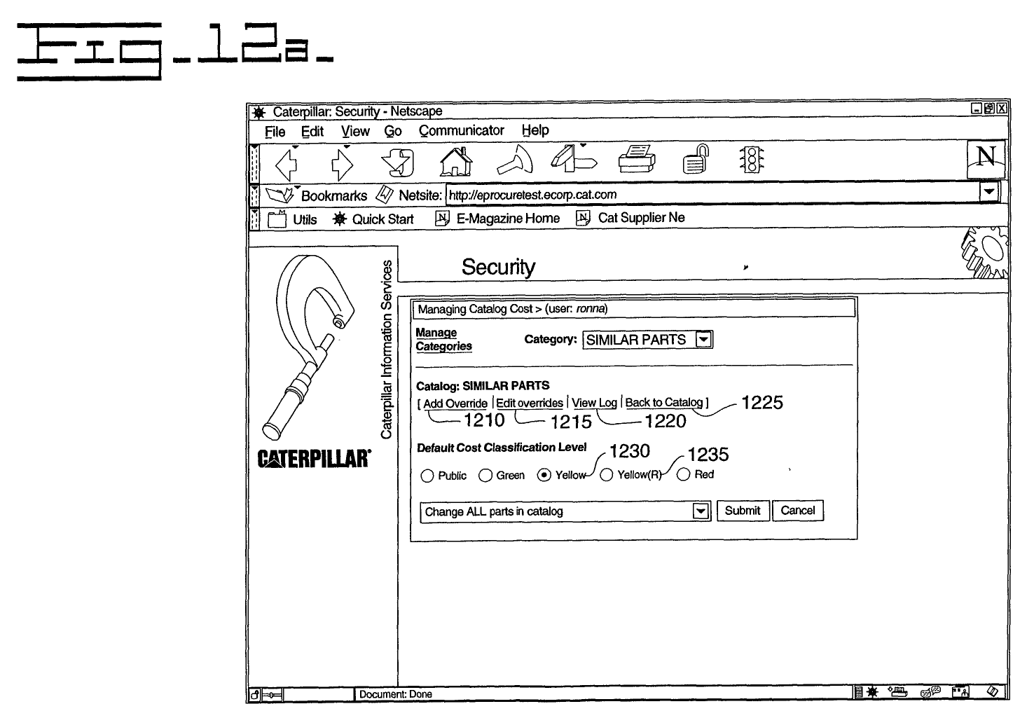

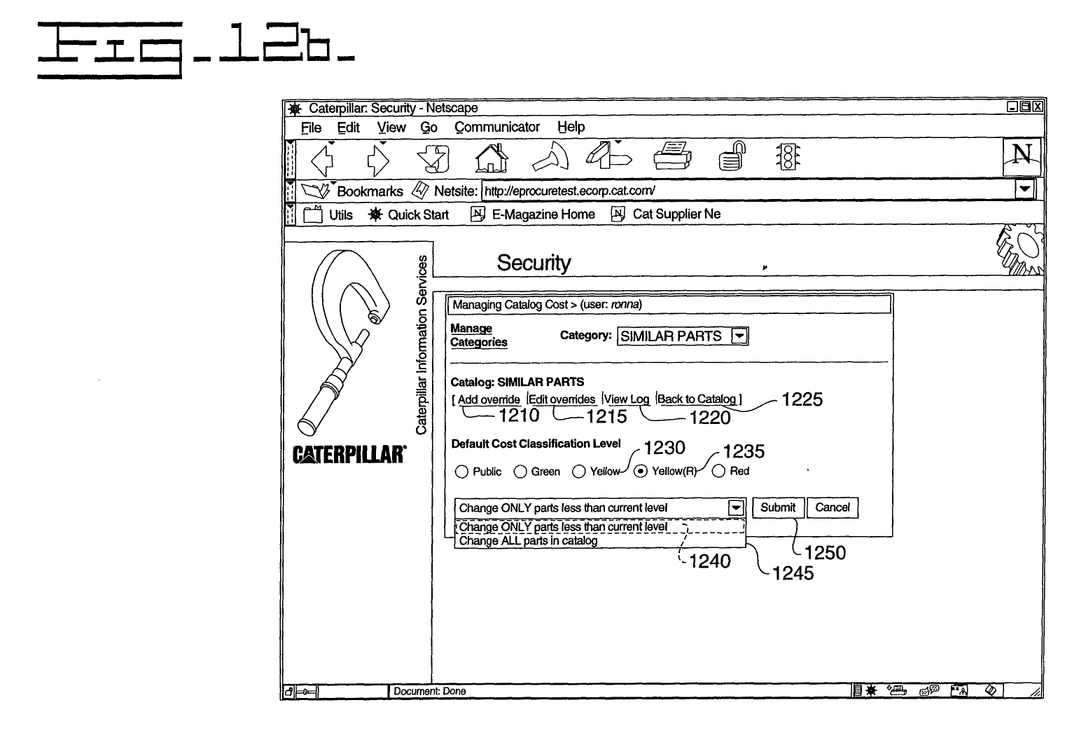

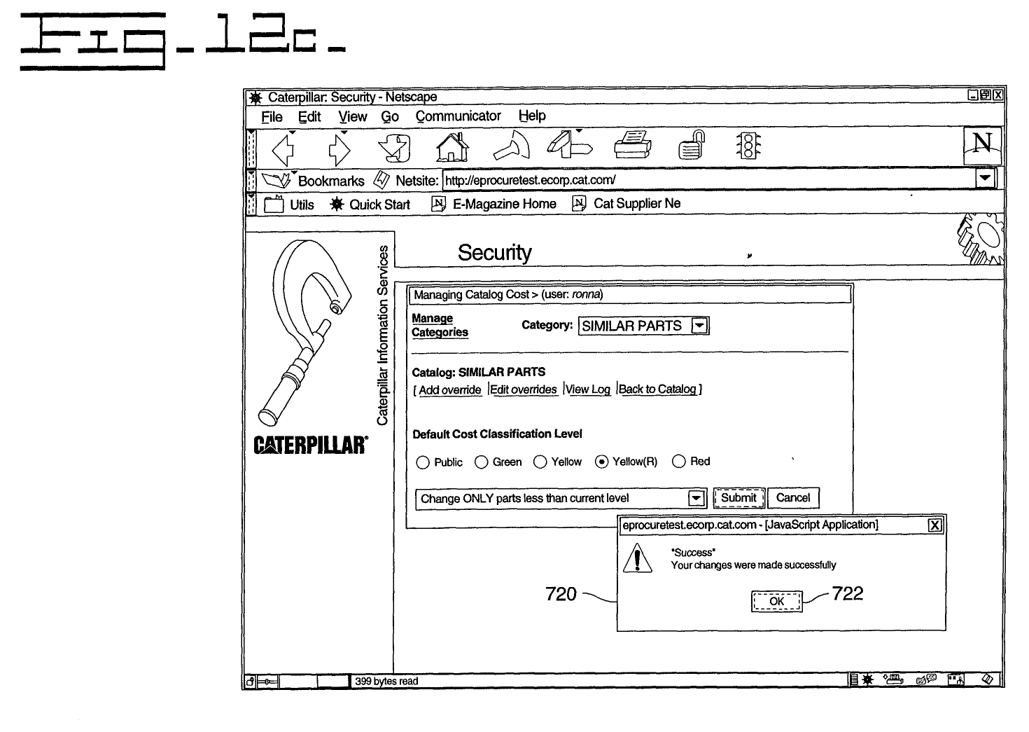

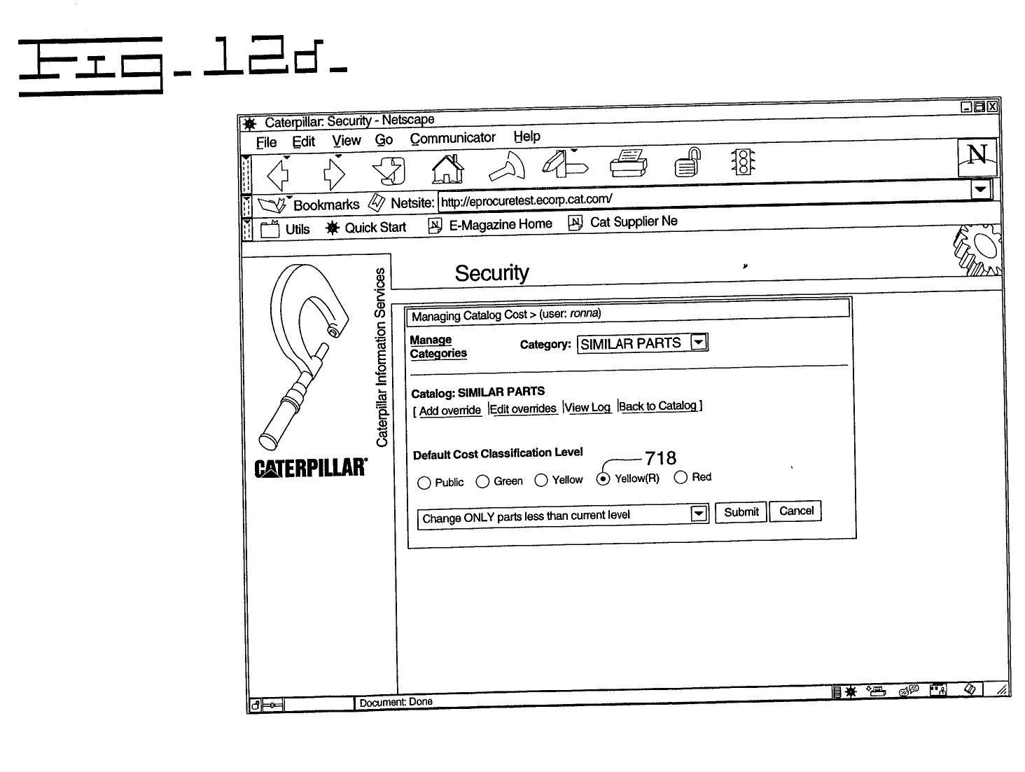

Finally, in FIG. 3A, the administrator had an option of managing costs in a catalog by clicking the manage cost link 345. This would lead to the screen in FIG. 12A appearing. The user is presented with a number of familiar choices, Add Override 1210, Edit Override 1215, View Log 1220 and Back to Catalog 1225 which are discussed above. Further, the administrator is presented with the current security threshold, Yellow 1230, of price information for this particular catalog, Similar Parts. In one embodiment, in order to change the price threshold for the catalog, an administrator selects the new threshold, in this case Yellow(R) 1235 and select whether all parts in the catalog should be affected 1240, or only those that currently have a security level less than the current level 1245, in this case Yellow, both shown in FIG. 12B. When the administrator makes this selection, he presses the Submit button 1250, and the screen shown in FIG. 12C appears. The administrator is presented with a dialog box 720 that informs him the changes were made successfully, and he must press the OK button 722 to continue. FIG. 12D then appears, which shows the changes to the catalog just made I.E. Yellow(R) 718.

System

The system in accordance to the present invention may be built from a combination of off-the-shelf hardware and software packages and custom software. The system may exist on any conventional personal computer or workstation running a suitable operating system such as Windows™, Windows NT™, or Linux, for example. A suitable web browsing application, such as Microsoft Internet Explorer™ or Netscape™, for example may also be enabled for web-based application of the Security. One aspect of the present invention includes a technique by which a user can participate in the procurement of an part via an electronic network, such as the Internet or an Intranet, a Wide Area Network (WAN) or Local Area Network (LAN). These and other aspects of the present invention will be described below in greater detail.

In one embodiment, the present invention is carried out in a computer system by a microprocessor executing files containing sequences of instructions (e.g., Java, Java Server pages, or Hypertext Markup Language or “HTML” script embedded with graphics and other scripts) contained in a memory. The execution of these instructions cause the microprocessor to perform steps of the present invention, which are described below. The instructions may be loaded into computer-readable media for execution by the microprocessor from a storage type device. Also, the instructions may be received by the computer system via a network or wireless network from another computer system. In other embodiments, hardwired circuitry may be used in place of, or in combination with, software instructions to implement the present invention.

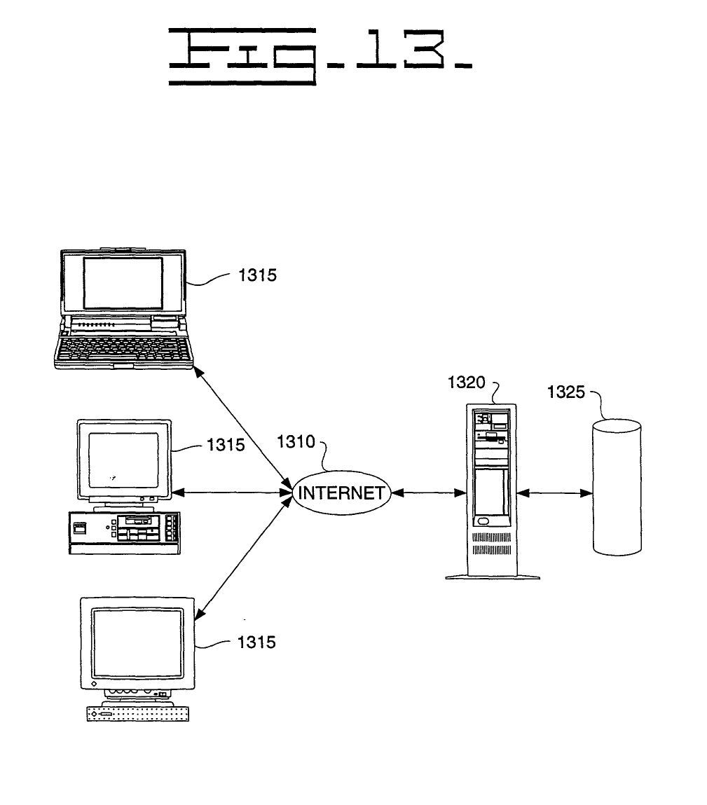

Referring now to the drawings, and initially to FIG. 13, in one embodiment of the invention, there is a connection via Internet 1310 between a client system 1315 and web server system 1320. Web server system 1320 is a multi-user, concurrent use system and includes a web server and other programs and files that can contain references to other files in addition to a computer system in which one or more web servers and other programs run. The web server system 1320 further includes a database 1325, such as a relational, distributed, or object-oriented database with logic functions, processing, creating and storage, and importation and exportation of data capabilities. More specifically, the web server within the web server system 1320 is a program that, using a client/server model and the World Wide Web's Hypertext Transfer Protocol or Secure Hypertext Transfer Protocol (“HTTP” or “HTTPS”), serves files containing information that form web pages to users whose client systems 1315 contain HTTP clients that forward their requests. For example, a web browser application, such as Microsoft Internet Explorer®, for example, is a HTTP client that sends requests to web server systems. When a user on a client system 1315 enters file requests by either “opening” a web file (typing in a Uniform Resource Locator or “URL”) or selecting a hypertext link, the web browser application builds an HTTP request and sends it to the internet protocol address indicated by the URL. The web server system 1320 receives such request and, after any necessary processing, the requested file is returned to the client system 1315.

The client system 1315 is a computer system that includes a bus, a microprocessor coupled with the bus for processing information, and a main memory, such as RAM or other dynamic storage device, coupled to the bus for storing information and instructions to be executed by the processor. The client system 1315 further includes ROM or other static storage device coupled to the bus for storing static information and instructions for the processor. A storage device, such as a magnetic disk or optical disk for example, is also provided and coupled to the bus for storing information and instructions. The client system 1315 also includes a communication device and various input/output devices, such as monitors, keyboards, pointing devices, or printers, both being coupled to the bus. The communication device provides the client system with a connection to the Internet 1310 and may be a device suitable for such purpose, such as a telephone or cable modem, ISDN adapter, or wireless adapter for example. Although the screenshots depicted in the figures are in the English language, they could also be displayed in any other language.

### EXAMPLE

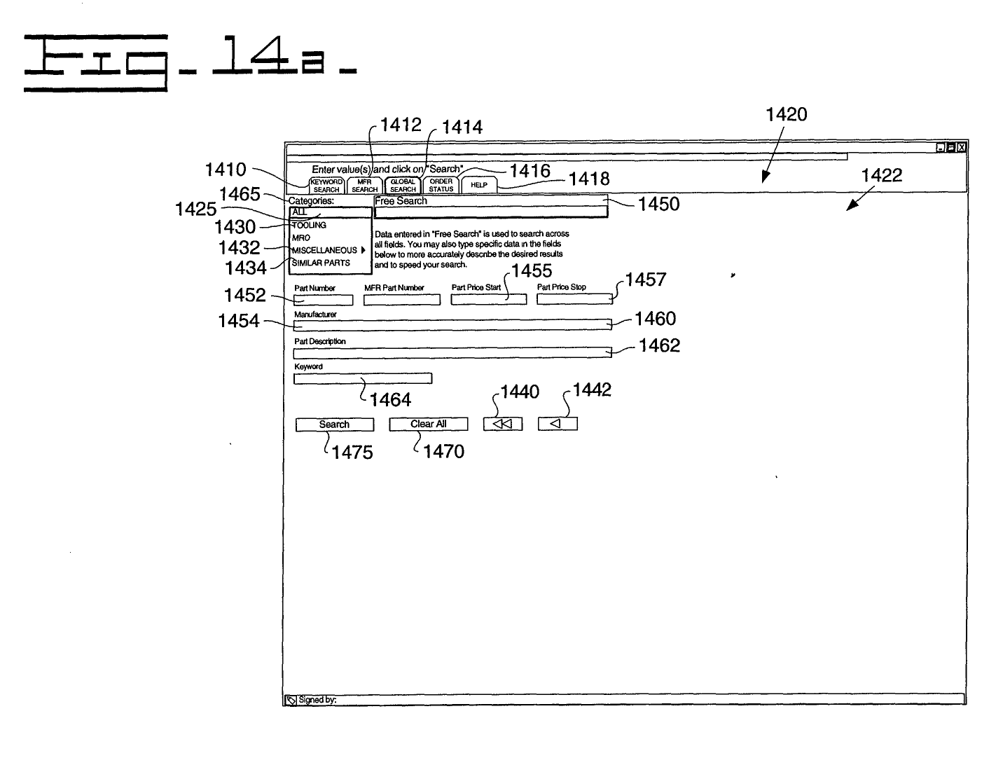

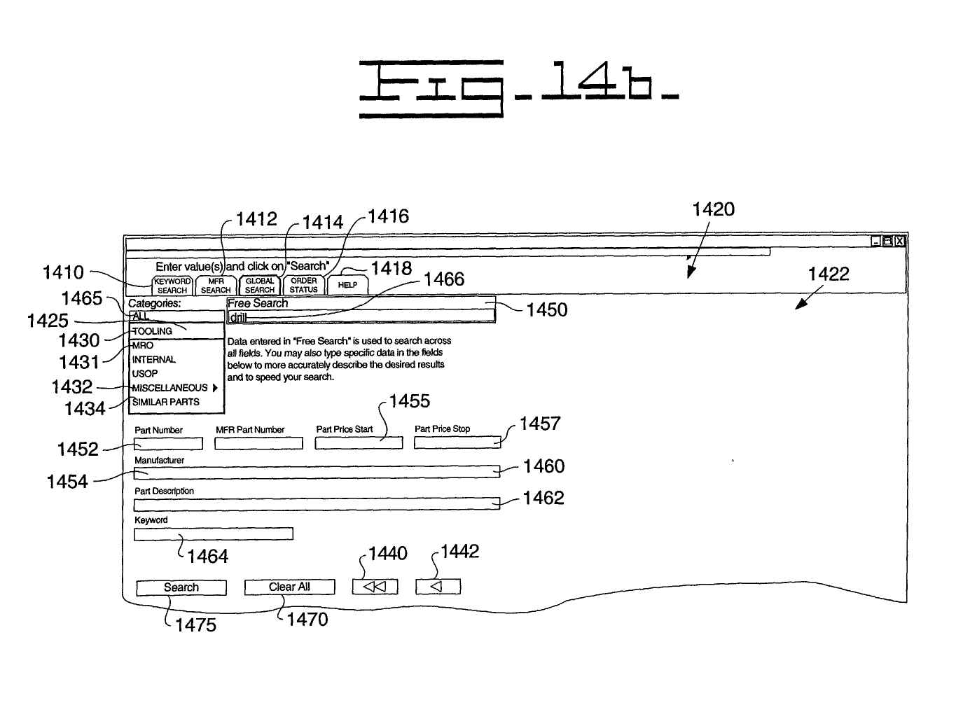

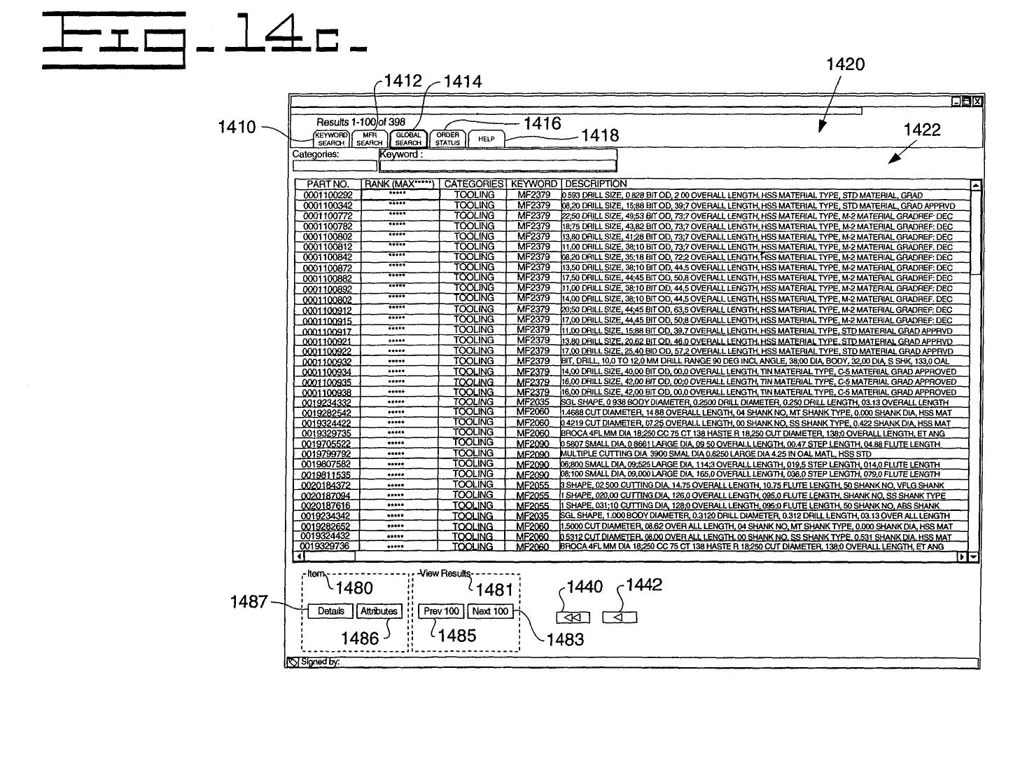

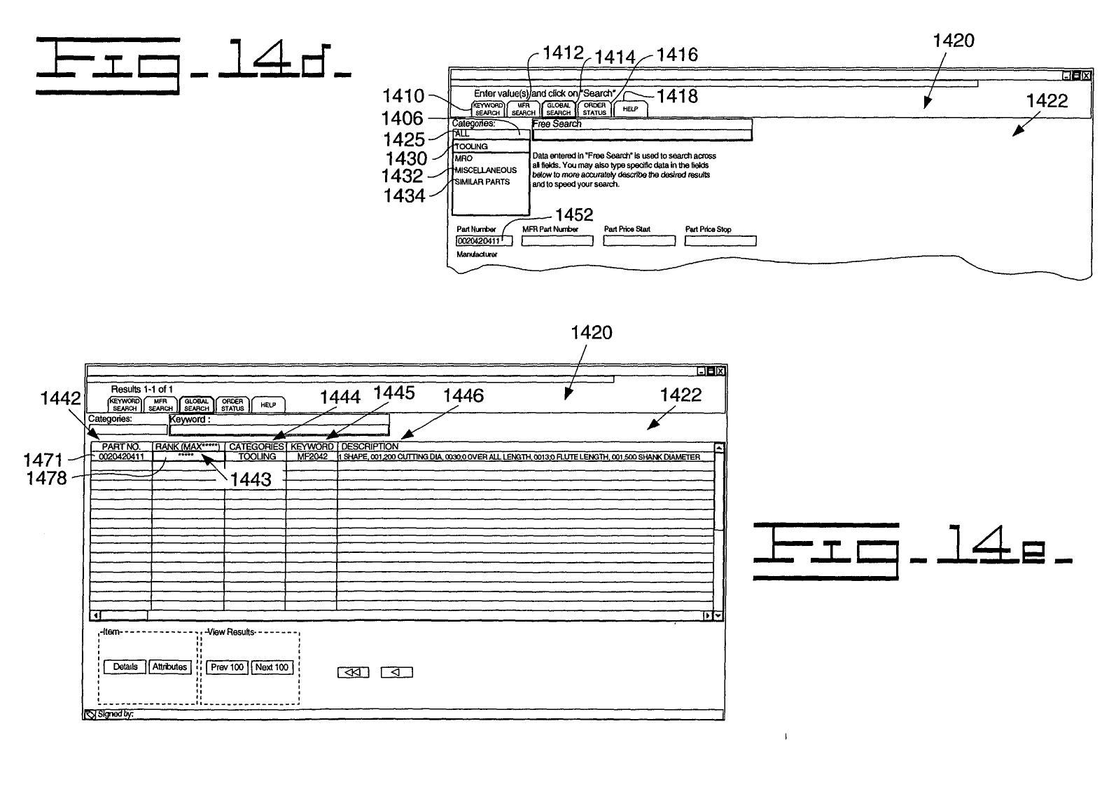

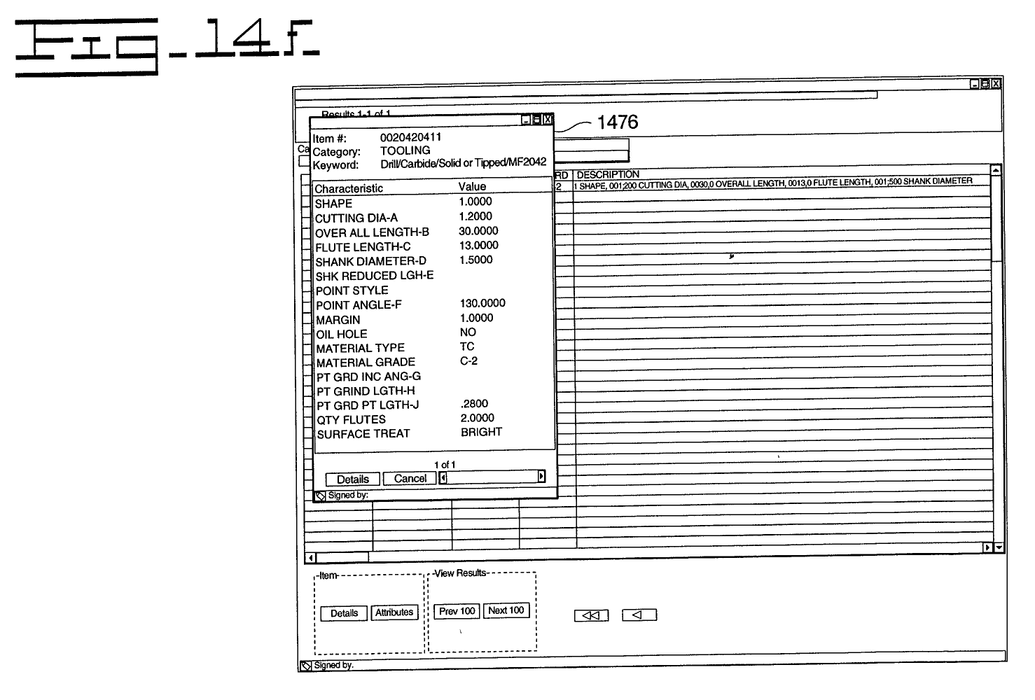

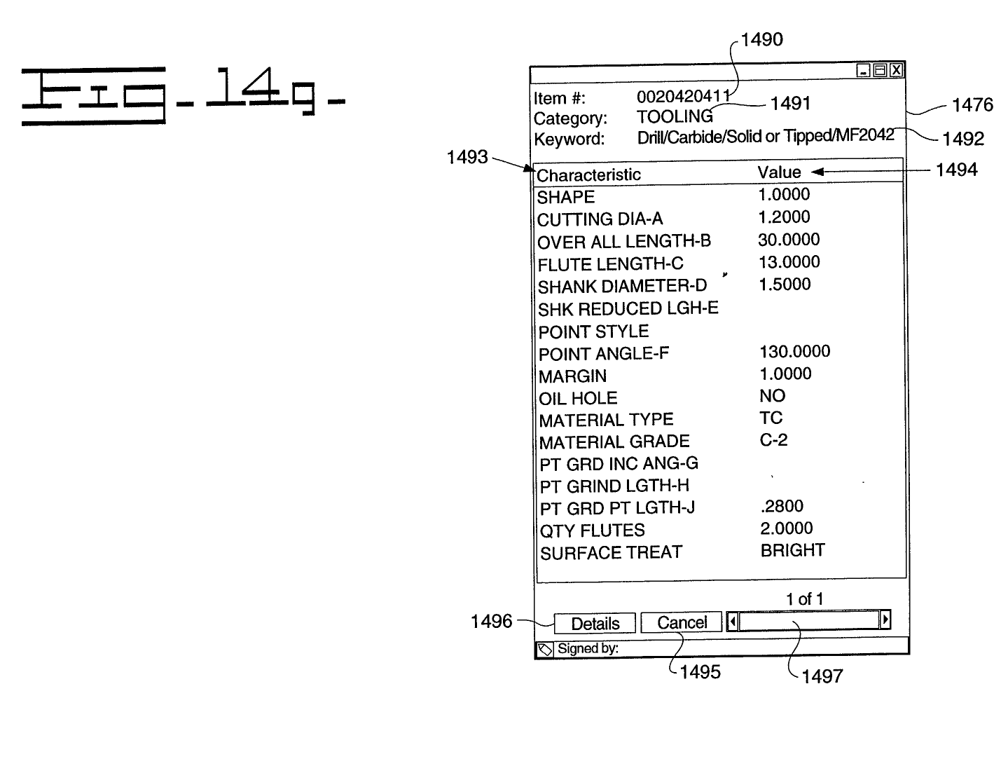

A nonlimiting example of the security functionality explained above can be shown in further detail with the aid of a search engine and the corresponding search results provided. Specifically, a global search module 1414, as shown in FIG. 14A is shown as the top module and generates search results for a desired part and will now be discussed. The initial screen showing the global search module 1414, as illustrated in FIG. 14A, is utilized for those occasions where a user knows some specific data with which to search or when a user desires to search more than one category or catalogue at a time. A user may first select the desired category(ies) or catalogue(s) from category selection box 1425. As explained above, any one or combination of catalogues may be hidden from the users access and view. In the Free Search field 1450 in FIG. 14A, a user may enter a keyword, description, attribute characteristic, specific attribute, or price, for example.

In a first example, upon selection of TOOLING 1430 within the category selection box 1425, a user may enter the keyword “drill” 1466 in the Free Search field 1450, as individually shown in FIG. 14B. If a user selects the “Search” button 1475, the next screen to appear in frame 1422 is shown in FIG. 14C. All parts returned will either match the search “drill” 1466 in part number, from the part_number field in the parts table 125, keyword, from the keyword field of the keyword table 130, or be found in the description of a part, from the part_desc field of the parts table 125. The global search module 1414 is specifically suited to narrowing the number of specific parts returned. Thus, the global search module 1414 searches within a catalogue or across several catalogues for a specific part(s) through specification of additional information, such as those in fields 1452-1464 in FIG. 14B. More specifically, the more fields 1452-1464 that are filled, the more efficient the search and the fewer specific parts that the user will have to look through. An entry in Part Number 1452 will search the part_number field in the parts table 125. An entry in MFR Part Number 1454 will search the mfg_part_number field in the parts table 125. An entry in Part Price Start 1455 will search the price field in the parts table 125 for all parts that are greater than the entered price. An entry in Part Price Stop 1457 will search the price field in the parts table 125 for all parts that are less than the entered price. An entry in Manufacturer 1460 will search the manufacturer field in a manufacturer table (not shown). An entry in Part Description 1462 will search the part_desc field in the parts table 125.

In a second example, if the user again selects catalogue TOOLING 1430 but additionally enters data in the Part Number field 1452, as individually shown in FIG. 14D, the search will be narrowed and provide only the specific part desired in the very first row 1471, as shown individually in FIG. 14E. Thus, the entry of 0020420411 in Part Number 1452 searched all the part_number fields to find a match.

The characteristics of the global search module 1414 as shown in FIG. 14E are displayed within several different columns. Specifically, the first column 1442 displays the part number of the item and the second column 1443 ranks the results of the search by how many of the search criteria have been matched. Although many variations could be used to indicate the level of matching, such as direct percentages, in this example five asterisks 1478 indicate that all of the criteria of the part shown match this specific search. A lower number of asterisks would indicate that a lower amount of criteria matched this specific search. Additionally the third column 1444 indicates which category(ies) or catalogue(s) contains the specific part. Likewise, the fourth column 1445 will contain the keyword that would have been the resultant specific part in a search using the keyword search module 1410. Similarly, the fifth column 1446 will contain a worded description including attribute characteristics and specific attributes that are on file for this particular specific part. As explained above, any of the information contained within these columns can be hidden from the users access and view.

Since there are no additional columns containing the specific attributes of the specific part selected, if a user desires to see such specific attributes of certain specific parts, the user may select the “Attributes” button 1486 within the Part box 1480, as shown in FIG. 14E. If selected, the enabled “Attributes” button 1486 will bring up window 1476, as generally shown in FIG. 14F, which overlays a portion of the existing screen, displaying the specific attributes for a specific part of the part highlighted in FIG. 14E. This new window 1476, as individually shown in FIG. 14G, begins with the Part Number field 1490, Category field 1491, and Keyword field 1492. The Part Number 1490 comes from the part_number field in the parts table. The Category field 1491 comes from the Keyword associated with the keyword_id field of the part in the parts table. The Keyword field 1492 comes from the keyword_path associated with the keyword_id of the part in the parts table. Window 1476 additionally displays the attribute characteristics in the first column 1493 and the specific attributes of that specific part in the second column 1494. Any of the attribute characteristics and/or specific attributes contained within window 1476 can be hidden from the users access and view. At the bottom of window 1476 as shown in FIG. 14G, is the “Cancel” button 1495, which will close window 1476 and return the user to the previous screen as well as the “Details” button 1496, which allows the user to view additional details about the item selected such all the available specifications including a detailed specific image.

Industrial Applicability

The described method and system for restricting access to a database, particularly as utilized in an e-procurement and inventory system provides a highly effective manner of allowing only particular users to have access to certain keywords, attribute characteristics, parts, or prices based on their jobs. There are many situations where certain users do not need to have access to certain parcels of data within a database. It is possible that the data is just unnecessary for a user and will thus waste their time looking at it. For example, a user who only deals with tooling aspects of a business, need not see data that involves office products when querying a database. Maybe the data is of a very sensitive nature, and only particular users should have access to it. An example of this might be the pricing information of a particular part. Maybe certain information would just clutter the judgement of a user, and the user would make a non-efficient decision. For example, a user might just need to know length, width and height of an object, but not what it is made of. If the user was aware of such information, he might base a decision on a characteristic of a part that has nothing to do with his job, and thus interfere with another user, whose job is to determine the material required for a part.

In one embodiment, a default access level may be assigned to all users of a database, granting them access to data parcels with a specific security threshold determined by the corporation. For instance, a corporation might determine minimum security levels for employees or independent contractors. Thus by default each category of user would be able to access corporate determined parcels of data. Thus users would generally be able to access data parcels that were necessary for their job without an administrator getting involved.

In certain situations, certain users may be enabled to see particular parcels of data that would typically have a greater security threshold than their current default security level. For instance, a tooling manager may have a need to see more data than a typical tooling employee. In this case the security threshold of certain parcels of tooling data may be overriden. At the same time, there is no reason that the tooling manager need to have greater access to other parcels of data like office products. Allowing security to be category specific, allows a database to maintain a high security threshold, yet offer great flexibility in administering it.

In one embodiment, a highly customizable way of administering access to a database is provided. An administrator may need to be able to assign security levels to the different parcels of data. In a procurement context, an administrator would find it helpful to assign security thresholds to keywords, keyword characteristics, and parts. Each individual data parcel should be able to have its own specified security threshold. Further an administrator should be able to set overrides for users with relative ease. An administrator should be able to quickly allow a user access to specific keywords, keyword characteristics, and parts if his job requires it, and yet his default security level is not high enough. Further when a change to a parcel of data's security threshold occurs, or a users default security level changes the system should be able to instantly eliminate any (now unnecessary) overrides that were previously necessary for that user.

One embodiment of the invention provides an easy way of allowing users to become administrators, and specifying what they are able to administer. Since it is difficult for one person to administer an entire database of thousands of parts for thousands of employees, there needs to be a way to delegate the administrative responsibility amongst several administrators. For instance, a tooling manager might be given the responsibility of being an administrator of tooling parts, since he probably has the best idea of what his employees need in order to complete their job. The tooling manager though doesn't need to administer office supplies, and thus should just have the ability to administer tooling data. Providing this kind of administering flexibility would be a great advantage in database access and security.

Further, in the interest of security, it would be advantageous to provide access to the database by exclusion and not by inclusion. This means that by default a user will not be able to see parcels of data with a security threshold greater than his security level, unless an administrator has taken an affirmative step to remedy that situation. This is unlike an inclusive scheme, where a user has access to all of the data parcels, except that which he has been specifically prevented from accessing. The exclusive method will tend to make access to the data parcels more secure, since if an administrator forgets to give a user an override to a particular data parcel, no security of data parcels is compromised, it just is inconvenient to that user until it is remedied. If an administrator forgot to prevent user access to a data parcel under an inclusive scheme, the user would not only be able to see the data parcel, but there would be no reason for the user to inform the administrator thus compromising the security of the database.

Based on the above description, the more user specific a users access to data is, the more efficient he can do his job. In order to allow such user dependant access, there is a need for a database that would be highly customizable with regard to what kinds of data a user can access, and the way the access of users is administrated.

The invention and the manner and process of making and using it are now described in such full, clear, concise and exact terms as to enable any person skilled in the art to which it pertains, to make and use the same. It is to be understood that the foregoing describes preferred embodiments of the present invention and that modifications may be made therein without departing from the spirit or scope of the present invention as set forth in the claims. To particularly point out and distinctly claim the subject matter regarded as invention, the following claims conclude this specification.

What is claimed is:

1. A method of restricting user access to parcels of data in a database of product items used in a procurement system comprising:
assigning a security threshold to each parcel of data in said database;
assigning a security level to each user of said database;
allowing access to a particular parcel of data to a particular user only when the security level of the particular user is at least equal to the security threshold of the particular parcel of data.

2. The method of claim 1, wherein said parcels of data are returned to the user as the result of a search request.

3. The method of claim 1, wherein an administrator can change the security level of a particular user with respect to a particular parcel of data.

4. The method of claim 2, wherein a super administrator can determine which users of said database are administrators.

5. A computer data signal embodied in a carrier wave and encoding a plurality of sequences of instructions which, when executed by a processor, cause said processor to protect parcels of data in a database of product items by performing the steps of:
assigning a security threshold to each parcel of data in a database;
assigning a security level to each user of said database;
allowing access to a particular parcel of data to a particular user only
when the security level of the particular user is at least equal to the security threshold of the particular parcel of data.

6. The computer data signal of claim 5, wherein said parcels of data are returned to the user as the result of a search request.

7. The computer data signal of claim 5, wherein an administrator can change the security level of a particular user with respect to a particular parcel of data.

8. The computer data signal of claim 5, wherein a super administrator can determine which users of said database are administrators.

9. A computer-readable medium having a plurality of sequences of instructions stored thereon which, when executed by a processor cause said processor to perform the steps of:
assigning a security threshold to each parcel of data in a database of product items;
assigning a security level to each user of said database;
allowing access to a particular parcel of data to a particular user only when the security level of the particular user is at least equal to the security threshold of the particular parcel of data.

10. The computer-readable medium of claim 9, wherein said parcels of data are returned to the user as the result of a search request.

11. The computer-readable medium of claim 9, wherein an administrator can change the security level of a particular user with respect to a particular parcel of data.

12. The computer-readable medium of claim 9, wherein a super administrator can determine which users of said database are administrators.

13. An apparatus allowing the restriction of user access to parcels of data in a database of product items comprising:
a) means for assigning a security threshold to each parcel of data in said database;
b) means for assigning a security level to each user of said database;
c) means for allowing access to a particular parcel of data to a particular user only when the security level of the particular user is at least equal to the security threshold of the particular parcel of data.
